(19) United States
(12) Patent Application Publication
(10) Pub. No.: US 2015/0358777 A1
(43) Pub. Date: Dec. 10, 2015

(54) GENERATING A LOCATION PROFILE OF AN INTERNET OF THINGS DEVICE BASED ON AUGMENTED LOCATION INFORMATION ASSOCIATED WITH ONE OR MORE NEARBY INTERNET OF THINGS DEVICES

(71) Applicant: QUALCOMM Incorporated, San Diego, CA (US)

(72) Inventor: Binita GUPTA, San Diego, CA (US)

(21) Appl. No.: 14/723,195

(22) Filed: May 27, 2015

Related U.S. Application Data
(60) Provisional application No. 62/007,720, filed on Jun. 4, 2014.

(51) Int. Cl. H04W 4/02; H04W 4/00

(52) U.S. Cl. CPC H04W 4/023; H04W 4/008; H04W 84/18

(57) ABSTRACT

In an embodiment, an Internet of Things (IoT) device obtains augmented location information (ALI) that identifies (i) one or more device classifications (e.g., mobile, geo-static, etc.) for one or more IoT devices near the IoT device in the IoT environment and/or (ii) immediate surroundings (e.g., a picture, an audio recording, etc.) of the one or more IoT devices, and generates a location profile of the IoT device based on the obtained ALI. In another embodiment, a power-limited IoT device selects a proxy IoT device. The selected proxy IoT device performs an ALI reporting function on behalf of the power-limited IoT device, while the power-limited IoT device refrains from performing the ALI reporting function.

### CROSS-REFERENCE TO RELATED APPLICATION

The present Application for Patent claims benefit of U.S. Provisional Application No. 62/007,720, entitled “GENERATING A LOCATION PROFILE OF AN INTERNET OF THINGS DEVICE BASED ON AUGMENTED LOCATION INFORMATION ASSOCIATED WITH ONE OR MORE NEARBY INTERNET OF THINGS DEVICES”, filed Jun. 4, 2014, assigned to the assignee hereof, and expressly incorporated herein by reference in its entirety.

### FIELD

Embodiments relate to generating a location profile of an internet of things (IoT) device based on augmented location information (ALI) associated with one or more nearby IoT devices.

### BACKGROUND

The Internet is a global system of interconnected computers and computer networks that use a standard Internet protocol suite (e.g., the Transmission Control Protocol (TCP) and Internet Protocol (IP)) to communicate with each other. The Internet of Things (IoT) is based on the idea that everyday objects, not just computers and computer networks, can be readable, recognizable, locatable, addressable, and controllable via an IoT communications network (e.g., an ad-hoc system or the Internet).

A number of market trends are driving development of IoT devices. For example, increasing energy costs are driving governments' strategic investments in smart grids and support for future consumption, such as for electric vehicles and public charging stations. Increasing health care costs and aging populations are driving development for remote/connected health care and fitness services. A technological revolution in the home is driving development for new “smart” services (e.g. smart home appliances), including consolidation by service providers marketing ‘N’ play (e.g., data, voice, video, security, energy management, etc.) and expanding home networks. Buildings are getting smarter and more convenient as a means to reduce operational costs for enterprise facilities.

There are a number of key applications for the IoT. For example, in the area of smart grids and energy management, utility companies can optimize delivery of energy to homes and businesses while customers can better manage energy usage. In the area of home and building automation, smart homes and buildings can have centralized control over virtually any device or system in the home or office, from appliances to plug-in electric vehicle (PEV) security systems. In the field of asset tracking, enterprises, hospitals, factories, and other large organizations can accurately track the locations of high-value equipment, patients, vehicles, and so on. In the area of health and wellness, doctors can remotely monitor patients' health while people can track the progress of fitness routines.

Certain IoT devices may be mobile, in which case, a user may misplace or forget where he/she placed one or more mobile IoT devices from time to time. It is generally difficult to pinpoint the location of such mobile IoT devices at a granularity that would be relevant to a user searching for the devices within a particular IoT environment. For example, conventional solutions for identifying a lost IoT device (e.g., a cell phone, a tablet PC, etc.) include requesting that the “lost” IoT device emit a noise (e.g., a periodic beeping noise or other alert sound) that is detectable by the user from which the user can track down the device location, or to report a coarse location estimate such as a GPS location or a current WiFi hotspot or cell tower to which the lost IoT device is connected. However, the user may be out-of-range of the noise (or the IoT environment could simply be really loud) and the GPS location may only function to confirm that the lost device is in a particular IoT environment (as opposed to being stolen or otherwise off the premises) without providing much information on where the lost device is located within the IoT environment.

### SUMMARY

In an embodiment, an Internet of Things (IoT) device obtains augmented location information (ALI) that identifies (i) one or more device classifications (e.g., mobile, geo-static, etc.) for one or more IoT devices near the IoT device in the IoT environment and/or (ii) immediate surroundings (e.g., a picture, an audio recording, etc.) of the one or more IoT devices, and generates a location profile of the IoT device based on the obtained ALI. In another embodiment, a power-limited IoT device selects a proxy IoT device. The selected proxy IoT device performs an ALI reporting function on behalf of the power-limited IoT device, while the power-limited IoT device refrains from performing the ALI reporting function.

### BRIEF DESCRIPTION OF THE DRAWINGS

A more complete appreciation of aspects of the disclosure and many of the attendant advantages thereof will be readily obtained as the same becomes better understood by reference to the following detailed description when considered in connection with the accompanying drawings which are presented solely for illustration and not limitation of the disclosure, and in which:

FIG. 1A illustrates a high-level system architecture of a wireless communications system in accordance with an aspect of the disclosure.

FIG. 1B illustrates a high-level system architecture of a wireless communications system in accordance with another aspect of the disclosure.

FIG. 1C illustrates a high-level system architecture of a wireless communications system in accordance with an aspect of the disclosure.

FIG. 1D illustrates a high-level system architecture of a wireless communications system in accordance with an aspect of the disclosure.

FIG. 1E illustrates a high-level system architecture of a wireless communications system in accordance with an aspect of the disclosure.

FIG. 2A illustrates an exemplary Internet of Things (IoT) device in accordance with aspects of the disclosure, while FIG. 2B illustrates an exemplary passive IoT device in accordance with aspects of the disclosure.

FIG. 3 illustrates a communication device that includes logic configured to perform functionality in accordance with an aspect of the disclosure.

FIG. 4 illustrates an exemplary server according to various aspects of the disclosure.

FIG. 5 illustrates an example of an IoT environment (or distributed IoT network) in accordance with an embodiment of the invention.

FIG. 6 illustrates a high-level process of generating a location profile of a given IoT device in accordance with an embodiment of the invention.

FIG. 7 illustrates an example implementation of the process of FIG. 6 in accordance with an embodiment of the invention.

FIG. 8 illustrates another example implementation of the process of FIG. 6 in accordance with an embodiment of the invention.

FIG. 9 illustrates an example implementation of IoT environment scanning in accordance with an embodiment of the invention.

FIG. 10 illustrates ranges of example scanning technologies used during the process of

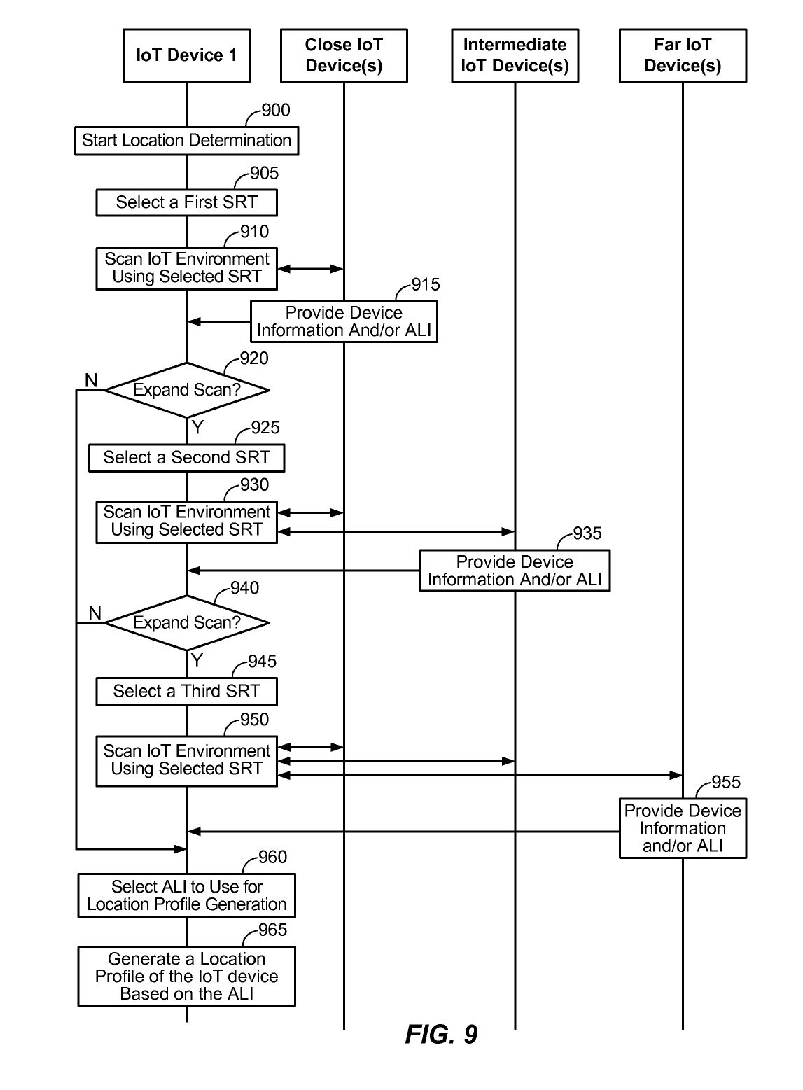

FIG. 9 in accordance with an embodiment of the invention.

FIG. 11 illustrates a process by which a power-limited IoT device sets up another IoT device as a proxy for an augmented location information (ALI) reporting function of the power-limited IoT device in accordance with an embodiment of the invention.

FIG. 12 illustrates a more detailed implementation of the proxy selection logic that executes during FIG. 11 in accordance with an embodiment of the invention.

FIG. 13 illustrates an example of an ALI reporting function being implemented by a proxy IoT device in accordance with an embodiment of the invention.

### DETAILED DESCRIPTION

Various aspects are disclosed in the following description and related drawings to show specific examples relating to exemplary embodiments of proximity detection between Internet of Things (IoT) devices. Alternate embodiments will be apparent to those skilled in the pertinent art upon reading this disclosure, and may be constructed and practiced without departing from the scope or spirit of the disclosure. Additionally, well-known elements will not be described in detail or may be omitted so as to not obscure the relevant details of the aspects and embodiments disclosed herein.

The word “exemplary” is used herein to mean “serving as an example, instance, or illustration.” Any embodiment described herein as “exemplary” is not necessarily to be construed as preferred or advantageous over other embodiments. Likewise, the term “embodiments” does not require that all embodiments include the discussed feature, advantage or mode of operation.

The terminology used herein describes particular embodiments only and should be construed to limit any embodiments disclosed herein. As used herein, the singular forms “a,” “an,” and “the” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Further, many aspects are described in terms of sequences of actions to be performed by, for example, elements of a computing device. It will be recognized that various actions described herein can be performed by specific circuits (e.g., an application specific integrated circuit (ASIC)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

As used herein, the term “Internet of Things device” (or “IoT device”) may refer to any object (e.g., an appliance, a sensor, etc.) that has an addressable interface (e.g., an Internet protocol (IP) address, a Bluetooth identifier (ID), a near-field communication (NFC) ID, etc.) and can transmit information to one or more other devices over a wired or wireless connection. An IoT device may have a passive communication interface, such as a quick response (QR) code, a radio-frequency identification (RFID) tag, an NFC tag, or the like, or an active communication interface, such as a modem, a transceiver, a transmitter-receiver, or the like. An IoT device can have a particular set of attributes (e.g., a device state or status, such as whether the IoT device is on or off, open or closed, idle or active, available for task execution or busy, and so on, a cooling or heating function, an environmental monitoring or recording function, a light-emitting function, a sound-emitting function, etc.) that can be embedded in and/or controlled/monitored by a central processing unit (CPU), microprocessor, ASIC, or the like, and configured for connection to an IoT network such as a local ad-hoc network or the Internet. For example, IoT devices may include, but are not limited to, refrigerators, toasters, ovens, microwaves, freezers, dishwashers, dishes, hand tools, clothes washers, clothes dryers, furnaces, air conditioners, thermostats, televisions, light fixtures, vacuum cleaners, sprinklers, electricity meters, gas meters, etc., so long as the devices are equipped with an addressable communications interface for communicating with the IoT network. IoT devices may also include cell phones, desktop computers, laptop computers, tablet computers, personal digital assistants (PDAs), etc. Accordingly, the IoT network may be comprised of a combination of “legacy” Internet-accessible devices (e.g., laptop or desktop computers, cell phones, etc.) in addition to devices that do not typically have Internet-connectivity (e.g., dishwashers, etc.).

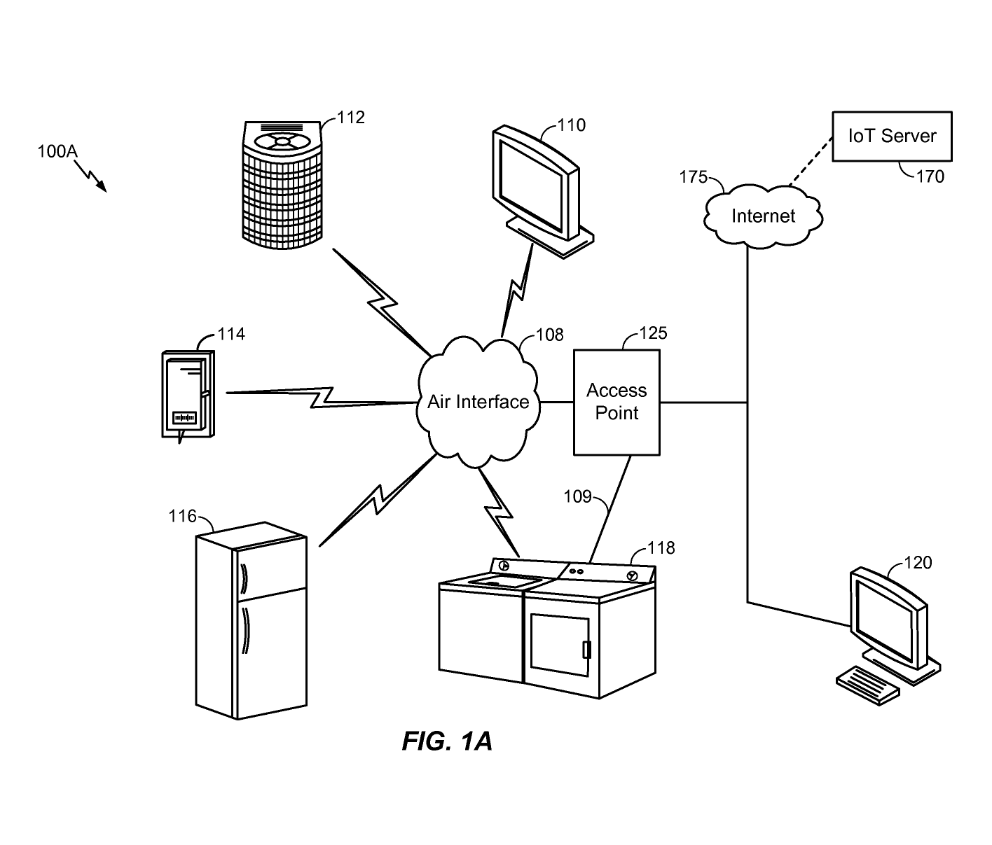

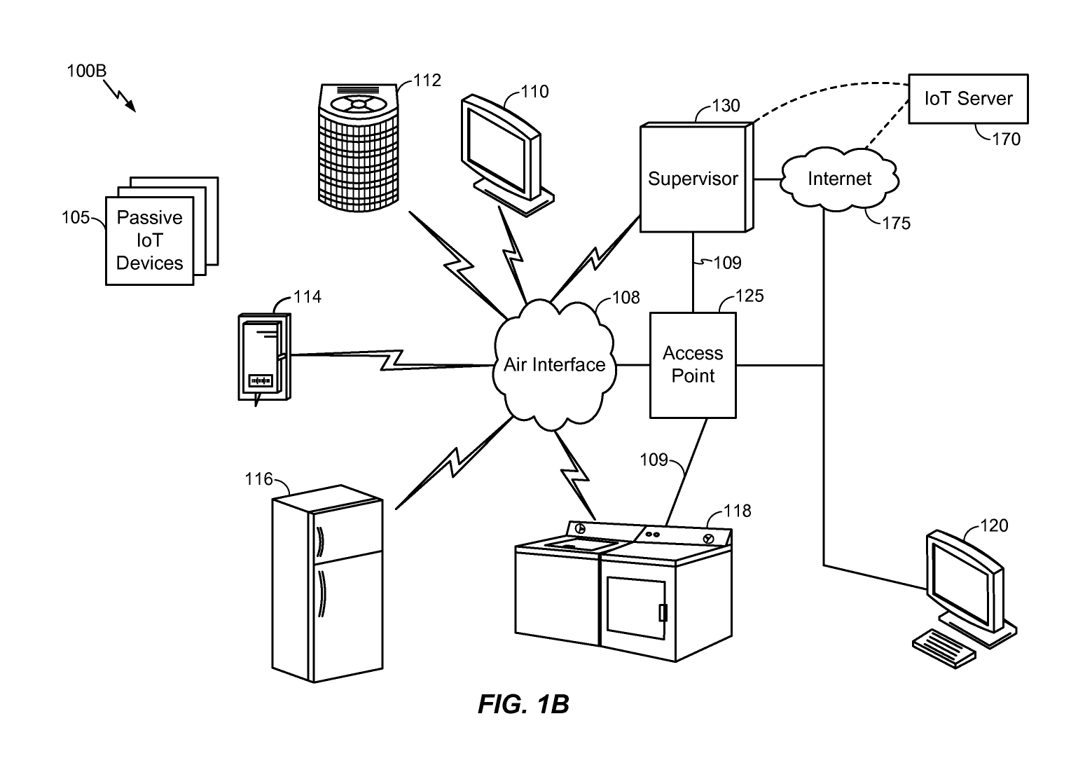

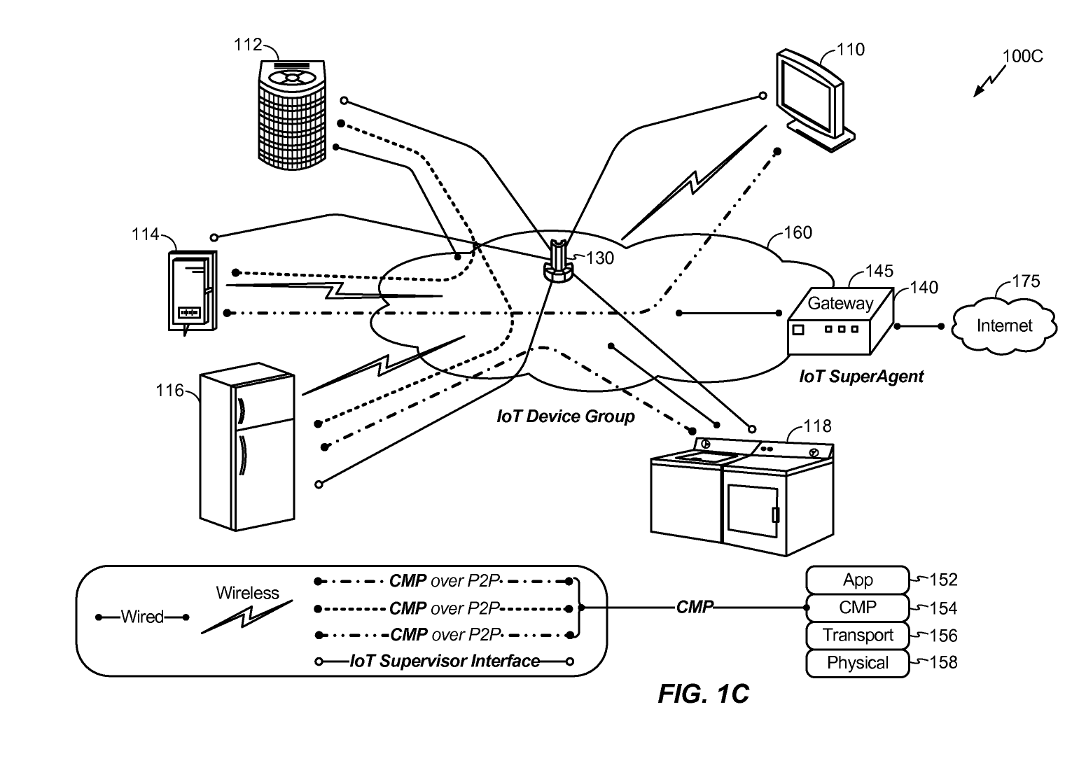

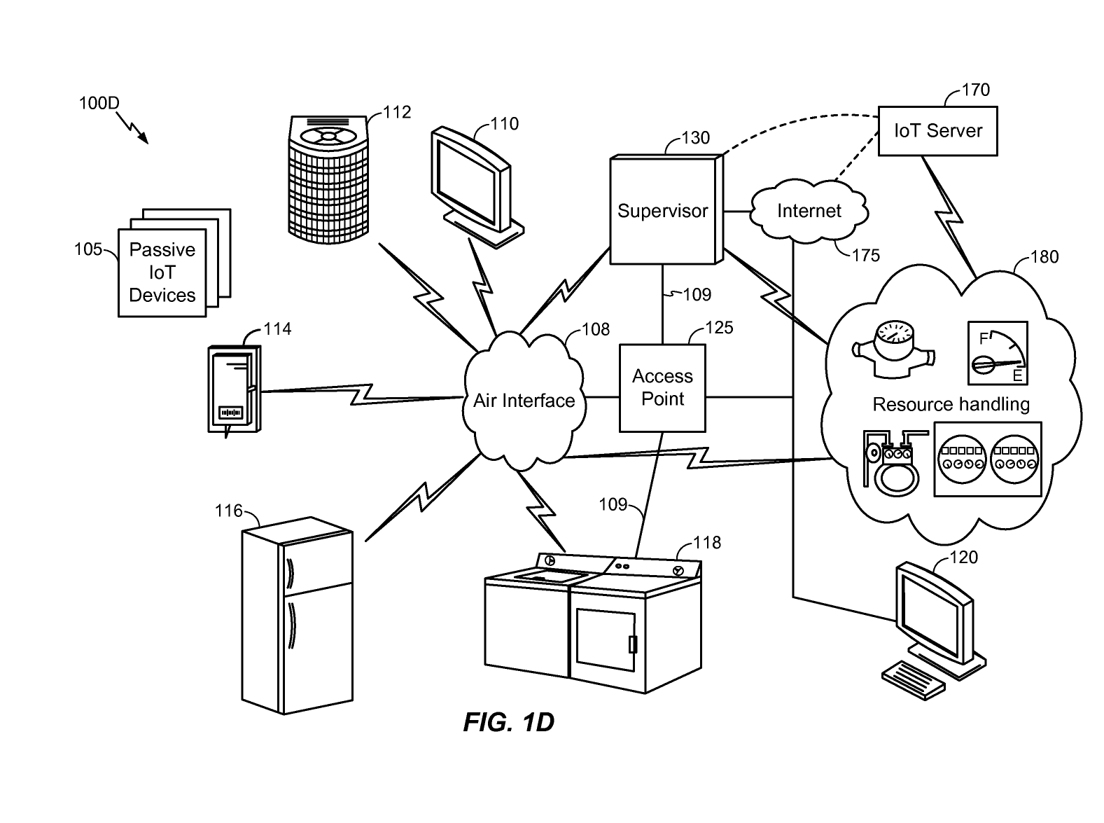

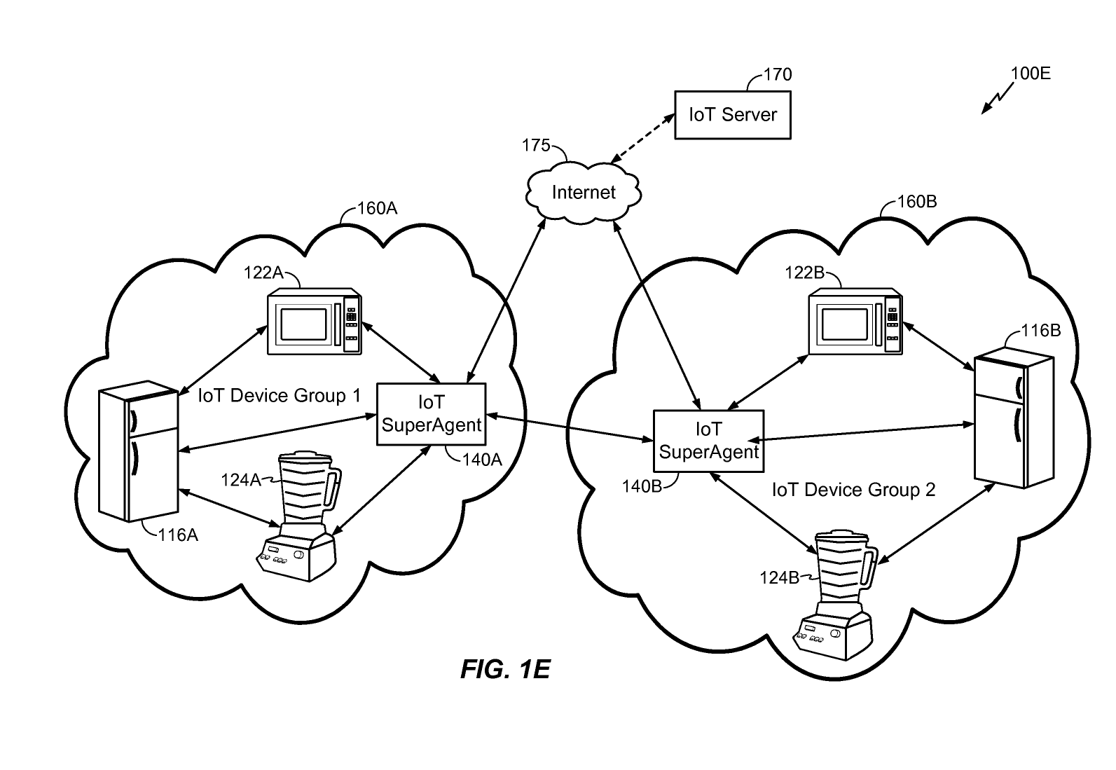

FIG. 1A illustrates a high-level system architecture of a wireless communications system 100A in accordance with an aspect of the disclosure. The wireless communications system 100A contains a plurality of IoT devices, which include a television 110, an outdoor air conditioning unit 112, a thermostat 114, a refrigerator 116, and a washer and dryer 118.

Referring to FIG. 1A, IoT devices 110-118 are configured to communicate with an access network (e.g., an access point 125) over a physical communications interface or layer, shown in FIG. 1A as air interface 108 and a direct wired connection 109. The air interface 108 can comply with a wireless Internet protocol (IP), such as IEEE 802.11. Although FIG. 1A illustrates IoT devices 110-118 communicating over the air interface 108 and IoT device 118 communicating over the direct wired connection 109, each IoT device may communicate over a wired or wireless connection, or both.

The Internet 175 includes a number of routing agents and processing agents (not shown in FIG. 1A for the sake of convenience). The Internet 175 is a global system of interconnected computers and computer networks that uses a standard Internet protocol suite (e.g., the Transmission Control Protocol (TCP) and IP) to communicate among disparate devices/networks. TCP/IP provides end-to-end connectivity specifying how data should be formatted, addressed, transmitted, routed and received at the destination.

In FIG. 1A, a computer 120, such as a desktop or personal computer (PC), is shown as connecting to the Internet 175 directly (e.g., over an Ethernet connection or Wi-Fi or 802.11-based network). The computer 120 may have a wired connection to the Internet 175, such as a direct connection to a modem or router, which, in an example, can correspond to the access point 125 itself (e.g., for a Wi-Fi router with both wired and wireless connectivity). Alternatively, rather than being connected to the access point 125 and the Internet 175 over a wired connection, the computer 120 may be connected to the access point 125 over air interface 108 or another wireless interface, and access the Internet 175 over the air interface. Although illustrated as a desktop computer, computer 120 may be a laptop computer, a tablet computer, a PDA, a smart phone, or the like. The computer 120 may be an IoT device and/or contain functionality to manage an IoT network/group, such as the network/group of IoT devices 110-118.

The access point 125 may be connected to the Internet 175 via, for example, an optical communication system, such as FiOS, a cable modem, a digital subscriber line (DSL) modem, or the like. The access point 125 may communicate with IoT devices 110-120 and the Internet 175 using the standard Internet protocols (e.g., TCP/IP).

Referring to FIG. 1A, an IoT server 170 is shown as connected to the Internet 175. The IoT server 170 can be implemented as a plurality of structurally separate servers, or alternately may correspond to a single server. In an aspect, the IoT server 170 is optional (as indicated by the dotted line), and the group of IoT devices 110-120 may be a peer-to-peer (P2P) network. In such a case, the IoT devices 110-120 can communicate with each other directly over the air interface 108 and/or the direct wired connection 109. Alternatively, or additionally, some or all of the IoT devices 110-120 may be configured with a communication interface independent of the air interface 108 and the direct wired connection 109. For example, if the air interface 108 corresponds to a Wi-Fi interface, certain of the IoT devices 110-120 may have Bluetooth or NFC interfaces for communicating directly with each other or other Bluetooth or NFC-enabled devices.

In a peer-to-peer network, service discovery schemes can multicast the presence of nodes, their capabilities, and group membership. The peer-to-peer devices can establish associations and subsequent interactions based on this information.

In accordance with an aspect of the disclosure, FIG. 1B illustrates a high-level architecture of another wireless communications system 100B that contains a plurality of IoT devices. In general, the wireless communications system 100B shown in FIG. 1B may include various components that are the same and/or substantially similar to the wireless communications system 100A shown in FIG. 1A, which was described in greater detail above (e.g., various IoT devices, including a television 110, outdoor air conditioning unit 112, thermostat 114, refrigerator 116, and washer and dryer 118, that are configured to communicate with an access point 125 over an air interface 108 and/or a direct wired connection 109, a computer 120 that directly connects to the Internet 175 and/or connects to the Internet 175 through access point 125, and an IoT server 170 accessible via the Internet 175, etc.). As such, for brevity and ease of description, various details relating to certain components in the wireless communications system 100B shown in FIG. 1B may be omitted herein to the extent that the same or similar details have already been provided above in relation to the wireless communications system 100A illustrated in FIG. 1A.

Referring to FIG. 1B, the wireless communications system 100B may include a supervisor device 130, which may alternatively be referred to as an IoT manager 130 or IoT manager device 130. As such, where the following description uses the term “supervisor device” 130, those skilled in the art will appreciate that any references to an IoT manager, group owner, or similar terminology may refer to the supervisor device 130 or another physical or logical component that provides the same or substantially similar functionality.

In one embodiment, the supervisor device 130 may generally observe, monitor, control, or otherwise manage the various other components in the wireless communications system 100B. For example, the supervisor device 130 can communicate with an access network (e.g., access point 125) over air interface 108 and/or a direct wired connection 109 to monitor or manage attributes, activities, or other states associated with the various IoT devices 110-120 in the wireless communications system 100B. The supervisor device 130 may have a wired or wireless connection to the Internet 175 and optionally to the IoT server 170 (shown as a dotted line). The supervisor device 130 may obtain information from the Internet 175 and/or the IoT server 170 that can be used to further monitor or manage attributes, activities, or other states associated with the various IoT devices 110-120. The supervisor device 130 may be a standalone device or one of IoT devices 110-120, such as computer 120. The supervisor device 130 may be a physical device or a software application running on a physical device. The supervisor device 130 may include a user interface that can output information relating to the monitored attributes, activities, or other states associated with the IoT devices 110-120 and receive input information to control or otherwise manage the attributes, activities, or other states associated therewith. Accordingly, the supervisor device 130 may generally include various components and support various wired and wireless communication interfaces to observe, monitor, control, or otherwise manage the various components in the wireless communications system 100B.

The wireless communications system 100B shown in FIG. 1B may include one or more passive IoT devices 105 (in contrast to the active IoT devices 110-120) that can be coupled to or otherwise made part of the wireless communications system 100B. In general, the passive IoT devices 105 may include barcoded devices, Bluetooth devices, radio frequency (RF) devices, RFID tagged devices, infrared (IR) devices, NFC tagged devices, or any other suitable device that can provide its identifier and attributes to another device when queried over a short range interface. Active IoT devices may detect, store, communicate, act on, and/or the like, changes in attributes of passive IoT devices.

For example, passive IoT devices 105 may include a coffee cup and a container of orange juice that each have an RFID tag or barcode. A cabinet IoT device and the refrigerator IoT device 116 may each have an appropriate scanner or reader that can read the RFID tag or barcode to detect when the coffee cup and/or the container of orange juice passive IoT devices 105 have been added or removed. In response to the cabinet IoT device detecting the removal of the coffee cup passive IoT device 105 and the refrigerator IoT device 116 detecting the removal of the container of the orange juice passive IoT device 105, the supervisor device 130 may receive one or more signals that relate to the activities detected at the cabinet IoT device and the refrigerator IoT device 116. The supervisor device 130 may then infer that a user is drinking orange juice from the coffee cup and/or likes to drink orange juice from a coffee cup.

Although the foregoing describes the passive IoT devices 105 as having some form of RF or barcode communication interfaces, the passive IoT devices 105 may include one or more devices or other physical objects that do not have such communication capabilities. For example, certain IoT devices may have appropriate scanner or reader mechanisms that can detect shapes, sizes, colors, and/or other observable features associated with the passive IoT devices 105 to identify the passive IoT devices 105. In this manner, any suitable physical object may communicate its identity and attributes and become part of the wireless communications system 100B and be observed, monitored, controlled, or otherwise managed with the supervisor device 130. Further, passive IoT devices 105 may be coupled to or otherwise made part of the wireless communications system 100A in FIG. 1A and observed, monitored, controlled, or otherwise managed in a substantially similar manner.

In accordance with another aspect of the disclosure, FIG. 1C illustrates a high-level architecture of another wireless communications system 100C that contains a plurality of IoT devices. In general, the wireless communications system 100C shown in FIG. 1C may include various components that are the same and/or substantially similar to the wireless communications systems 100A and 100B shown in FIGS. 1A and 1B, respectively, which were described in greater detail above. As such, for brevity and ease of description, various details relating to certain components in the wireless communications system 100C shown in FIG. 1C may be omitted herein to the extent that the same or similar details have already been provided above in relation to the wireless communications systems 100A and 100B illustrated in FIGS. 1A and 1B, respectively.

The wireless communications system 100C shown in FIG. 1C illustrates exemplary peer-to-peer communications between the IoT devices 110-118 and the supervisor device 130. As shown in FIG. 1C, the supervisor device 130 communicates with each of the IoT devices 110-118 over an IoT supervisor interface. Further, IoT devices 110 and 114, IoT devices 112, 114, and 116, and IoT devices 116 and 118, communicate directly with each other.

The IoT devices 110-118 make up an IoT device group 160. The IoT device group 160 is a group of locally connected IoT devices, such as the IoT devices connected to a user's home network. Although not shown, multiple IoT device groups may be connected to and/or communicate with each other via an IoT SuperAgent 140 connected to the Internet 175. At a high level, the supervisor device 130 manages intra-group communications, while the IoT SuperAgent 140 can manage inter-group communications. Although shown as separate devices, the supervisor device 130 and the IoT SuperAgent 140 may be, or reside on, the same device (e.g., a standalone device or an IoT device, such as computer 120 in FIG. 1A). Alternatively, the IoT SuperAgent 140 may correspond to or include the functionality of the access point 125. As yet another alternative, the IoT SuperAgent 140 may correspond to or include the functionality of an IoT server, such as IoT server 170. The IoT SuperAgent 140 may encapsulate gateway functionality 145.

Each IoT device 110-118 can treat the supervisor device 130 as a peer and transmit attribute/schema updates to the supervisor device 130. When an IoT device needs to communicate with another IoT device, it can request the pointer to that IoT device from the supervisor device 130 and then communicate with the target IoT device as a peer. The IoT devices 110-118 communicate with each other over a peer-to-peer communication network using a common messaging protocol (CMP). As long as two IoT devices are CMP-enabled and connected over a common communication transport, they can communicate with each other. In the protocol stack, the CMP layer 154 is below the application layer 152 and above the transport layer 156 and the physical layer 158.

In accordance with another aspect of the disclosure, FIG. 1D illustrates a high-level architecture of another wireless communications system 100D that contains a plurality of IoT devices. In general, the wireless communications system 100D shown in FIG. 1D may include various components that are the same and/or substantially similar to the wireless communications systems 100A-C shown in FIGS. 1A-C, respectively, which were described in greater detail above. As such, for brevity and ease of description, various details relating to certain components in the wireless communications system 100D shown in FIG. 1D may be omitted herein to the extent that the same or similar details have already been provided above in relation to the wireless communications systems 100A-C illustrated in FIGS. 1A-C, respectively.

The Internet 175 is a “resource” that can be regulated using the concept of the IoT. However, the Internet 175 is just one example of a resource that is regulated, and any resource could be regulated using the concept of the IoT. Other resources that can be regulated include, but are not limited to, electricity, gas, storage, security, and the like. An IoT device may be connected to the resource and thereby regulate it, or the resource could be regulated over the Internet 175. FIG. 1D illustrates several resources 180, such as natural gas, gasoline, hot water, and electricity, wherein the resources 180 can be regulated in addition to and/or over the Internet 175.

IoT devices can communicate with each other to regulate their use of a resource 180. For example, IoT devices such as a toaster, a computer, and a hairdryer may communicate with each other over a Bluetooth communication interface to regulate their use of electricity (the resource 180). As another example, IoT devices such as a desktop computer, a telephone, and a tablet computer may communicate over a Wi-Fi communication interface to regulate their access to the Internet 175 (the resource 180). As yet another example, IoT devices such as a stove, a clothes dryer, and a water heater may communicate over a Wi-Fi communication interface to regulate their use of gas. Alternatively, or additionally, each IoT device may be connected to an IoT server, such as IoT server 170, which has logic to regulate their use of the resource 180 based on information received from the IoT devices.

In accordance with another aspect of the disclosure, FIG. 1E illustrates a high-level architecture of another wireless communications system 100E that contains a plurality of IoT devices. In general, the wireless communications system 100E shown in FIG. 1E may include various components that are the same and/or substantially similar to the wireless communications systems 100A-D shown in FIGS. 1A-D, respectively, which were described in greater detail above. As such, for brevity and ease of description, various details relating to certain components in the wireless communications system 100E shown in FIG. 1E may be omitted herein to the extent that the same or similar details have already been provided above in relation to the wireless communications systems 100A-D illustrated in FIGS. 1A-D, respectively.

The wireless communications system 100E includes two IoT device groups 160A and 160B. Multiple IoT device groups may be connected to and/or communicate with each other via an IoT SuperAgent connected to the Internet 175. At a high level, an IoT SuperAgent may manage inter-group communications among IoT device groups. For example, in FIG. 1E, the IoT device group 160A includes IoT devices 116A, 122A, and 124A and an IoT SuperAgent 140A, while IoT device group 160B includes IoT devices 116B, 122B, and 124B and an IoT SuperAgent 140B. As such, the IoT SuperAgents 140A and 140B may connect to the Internet 175 and communicate with each other over the Internet 175 and/or communicate with each other directly to facilitate communication between the IoT device groups 160A and 160B. Furthermore, although FIG. 1E illustrates two IoT device groups 160A and 160B communicating with each other via IoT SuperAgents 140A and 140B, those skilled in the art will appreciate that any number of IoT device groups may suitably communicate with each other using IoT SuperAgents.

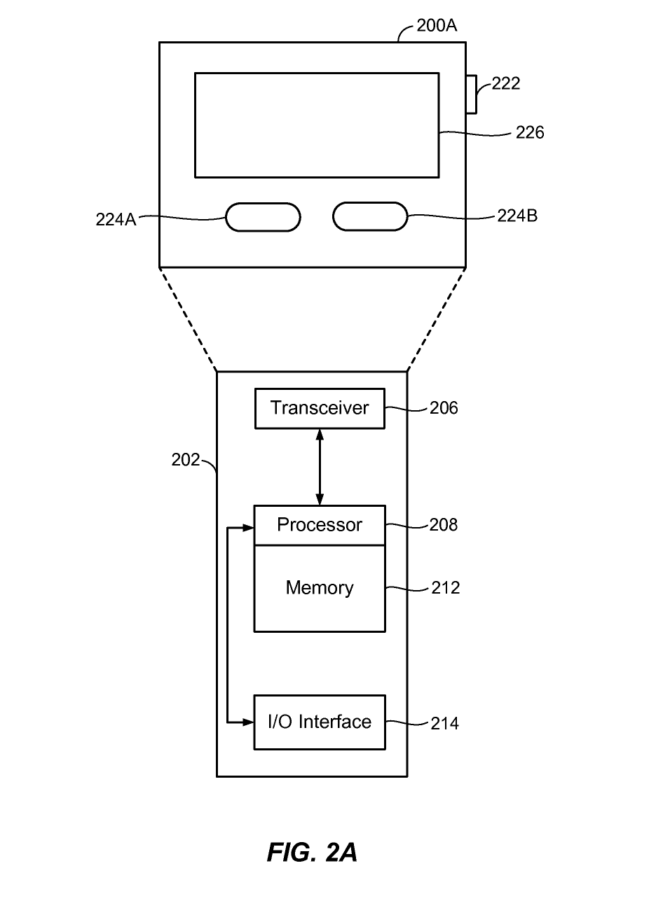

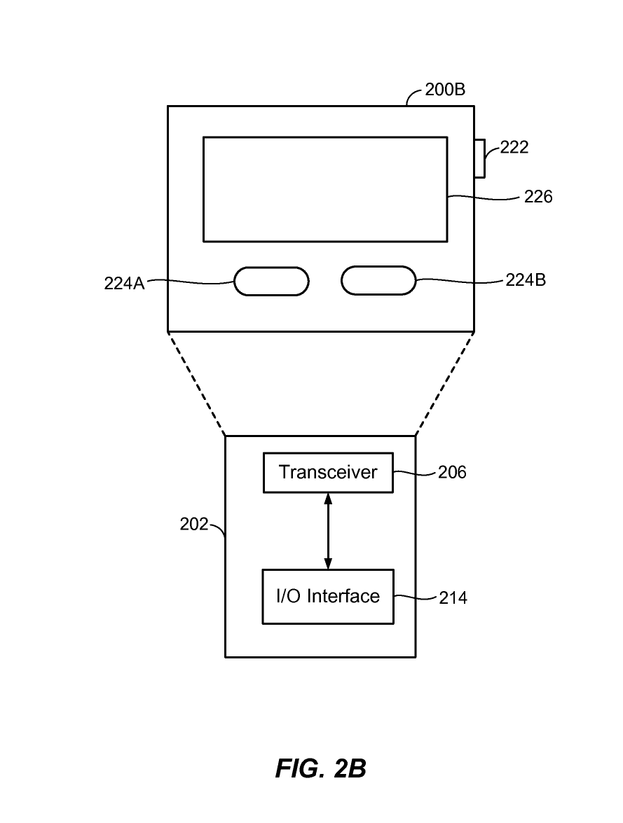

FIG. 2A illustrates a high-level example of an IoT device 200A in accordance with aspects of the disclosure. While external appearances and/or internal components can differ significantly among IoT devices, most IoT devices will have some sort of user interface, which may comprise a display and a means for user input. IoT devices without a user interface can be communicated with remotely over a wired or wireless network, such as air interface 108 in FIGS. 1A-B.

As shown in FIG. 2A, in an example configuration for the IoT device 200A, an external casing of IoT device 200A may be configured with a display 226, a power button 222, and two control buttons 224A and 224B, among other components, as is known in the art. The display 226 may be a touchscreen display, in which case the control buttons 224A and 224B may not be necessary. While not shown explicitly as part of IoT device 200A, the IoT device 200A may include one or more external antennas and/or one or more integrated antennas that are built into the external casing, including but not limited to Wi-Fi antennas, cellular antennas, satellite position system (SPS) antennas (e.g., global positioning system (GPS) antennas), and so on.

While internal components of IoT devices, such as IoT device 200A, can be embodied with different hardware configurations, a basic high-level configuration for internal hardware components is shown as platform 202 in FIG. 2A. The platform 202 can receive and execute software applications, data and/or commands transmitted over a network interface, such as air interface 108 in FIGS. 1A-B and/or a wired interface. The platform 202 can also independently execute locally stored applications. The platform 202 can include one or more transceivers 206 configured for wired and/or wireless communication (e.g., a Wi-Fi transceiver, a Bluetooth transceiver, a cellular transceiver, a satellite transceiver, a GPS or SPS receiver, etc.) operably coupled to one or more processors 208, such as a microcontroller, microprocessor, application specific integrated circuit, digital signal processor (DSP), programmable logic circuit, or other data processing device, which will be generally referred to as processor 208. The processor 208 can execute application programming instructions within a memory 212 of the IoT device. The memory 212 can include one or more of read-only memory (ROM), random-access memory (RAM), electrically erasable programmable ROM (EEPROM), flash cards, or any memory common to computer platforms. One or more input/output (I/O) interfaces 214 can be configured to allow the processor 208 to communicate with and control from various I/O devices such as the display 226, power button 222, control buttons 224A and 224B as illustrated, and any other devices, such as sensors, actuators, relays, valves, switches, and the like associated with the IoT device 200A.

Accordingly, an aspect of the disclosure can include an IoT device (e.g., IoT device 200A) including the ability to perform the functions described herein. As will be appreciated by those skilled in the art, the various logic elements can be embodied in discrete elements, software modules executed on a processor (e.g., processor 208) or any combination of software and hardware to achieve the functionality disclosed herein. For example, transceiver 206, processor 208, memory 212, and I/O interface 214 may all be used cooperatively to load, store and execute the various functions disclosed herein and thus the logic to perform these functions may be distributed over various elements. Alternatively, the functionality could be incorporated into one discrete component. Therefore, the features of the IoT device 200A in FIG. 2A are to be considered merely illustrative and the disclosure is not limited to the illustrated features or arrangement.

FIG. 2B illustrates a high-level example of a passive IoT device 200B in accordance with aspects of the disclosure. In general, the passive IoT device 200B shown in FIG. 2B may include various components that are the same and/or substantially similar to the IoT device 200A shown in FIG. 2A, which was described in greater detail above. As such, for brevity and ease of description, various details relating to certain components in the passive IoT device 200B shown in FIG. 2B may be omitted herein to the extent that the same or similar details have already been provided above in relation to the IoT device 200A illustrated in FIG. 2A.

The passive IoT device 200B shown in FIG. 2B may generally differ from the IoT device 200A shown in FIG. 2A in that the passive IoT device 200B may not have a processor, internal memory, or certain other components. Instead, in one embodiment, the passive IoT device 200A may only include an I/O interface 214 or other suitable mechanism that allows the passive IoT device 200B to be observed, monitored, controlled, managed, or otherwise known within a controlled IoT network. For example, in one embodiment, the I/O interface 214 associated with the passive IoT device 200B may include a barcode, Bluetooth interface, radio frequency (RF) interface, RFID tag, IR interface, NFC interface, or any other suitable I/O interface that can provide an identifier and attributes associated with the passive IoT device 200B to another device when queried over a short range interface (e.g., an active IoT device, such as IoT device 200A, that can detect, store, communicate, act on, or otherwise process information relating to the attributes associated with the passive IoT device 200B).

Although the foregoing describes the passive IoT device 200B as having some form of RF, barcode, or other I/O interface 214, the passive IoT device 200B may comprise a device or other physical object that does not have such an I/O interface 214. For example, certain IoT devices may have appropriate scanner or reader mechanisms that can detect shapes, sizes, colors, and/or other observable features associated with the passive IoT device 200B to identify the passive IoT device 200B. In this manner, any suitable physical object may communicate its identity and attributes and be observed, monitored, controlled, or otherwise managed within a controlled IoT network.

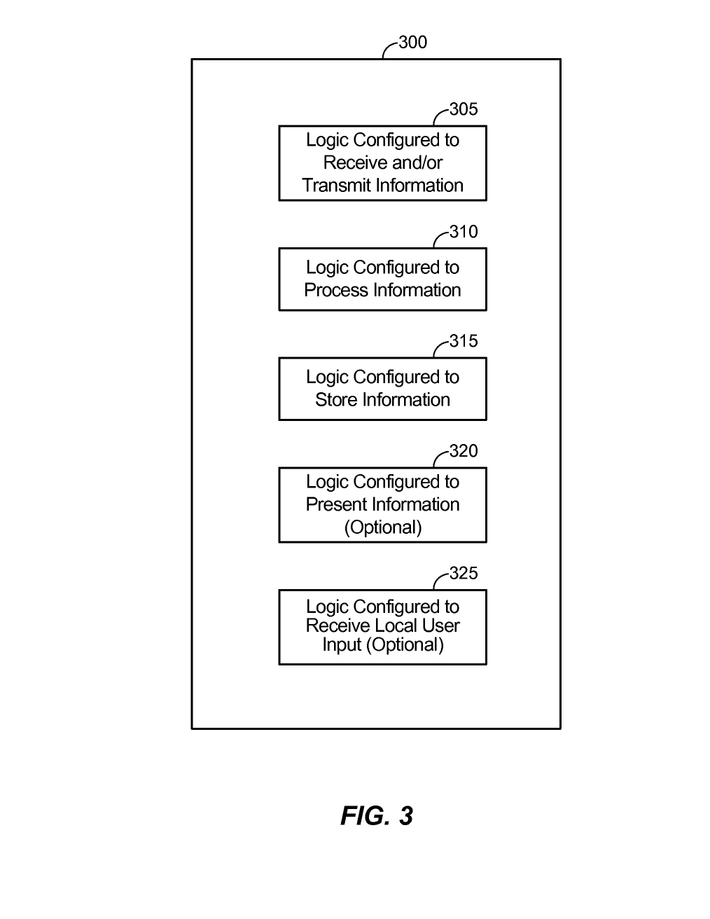

FIG. 3 illustrates a communication device 300 that includes logic configured to perform functionality. The communication device 300 can correspond to any of the above-noted communication devices, including but not limited to IoT devices 110-120, IoT device 200A, any components coupled to the Internet 175 (e.g., the IoT server 170), and so on. Thus, communication device 300 can correspond to any electronic device that is configured to communicate with (or facilitate communication with) one or more other entities over the wireless communications systems 100A-B of FIGS. 1A-B.

Referring to FIG. 3, the communication device 300 includes logic configured to receive and/or transmit information 305. In an example, if the communication device 300 corresponds to a wireless communications device (e.g., IoT device 200A and/or passive IoT device 200B), the logic configured to receive and/or transmit information 305 can include a wireless communications interface (e.g., Bluetooth, Wi-Fi, Wi-Fi Direct, Long-Term Evolution (LTE) Direct, etc.) such as a wireless transceiver and associated hardware (e.g., an RF antenna, a MODEM, a modulator and/or demodulator, etc.). In another example, the logic configured to receive and/or transmit information 305 can correspond to a wired communications interface (e.g., a serial connection, a USB or Firewire connection, an Ethernet connection through which the Internet 175 can be accessed, etc.). Thus, if the communication device 300 corresponds to some type of network-based server (e.g., the IoT server 170), the logic configured to receive and/or transmit information 305 can correspond to an Ethernet card, in an example, that connects the network-based server to other communication entities via an Ethernet protocol. In a further example, the logic configured to receive and/or transmit information 305 can include sensory or measurement hardware by which the communication device 300 can monitor its local environment (e.g., an accelerometer, a temperature sensor, a light sensor, an antenna for monitoring local RF signals, etc.). The logic configured to receive and/or transmit information 305 can also include software that, when executed, permits the associated hardware of the logic configured to receive and/or transmit information 305 to perform its reception and/or transmission function(s). However, the logic configured to receive and/or transmit information 305 does not correspond to software alone, and the logic configured to receive and/or transmit information 305 relies at least in part upon hardware to achieve its functionality.

Referring to FIG. 3, the communication device 300 further includes logic configured to process information 310. In an example, the logic configured to process information 310 can include at least a processor. Example implementations of the type of processing that can be performed by the logic configured to process information 310 includes but is not limited to performing determinations, establishing connections, making selections between different information options, performing evaluations related to data, interacting with sensors coupled to the communication device 300 to perform measurement operations, converting information from one format to another (e.g., between different protocols such as .wmv to .avi, etc.), and so on. For example, the processor included in the logic configured to process information 310 can correspond to a general purpose processor, a DSP, an ASIC, a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration). The logic configured to process information 310 can also include software that, when executed, permits the associated hardware of the logic configured to process information 310 to perform its processing function(s). However, the logic configured to process information 310 does not correspond to software alone, and the logic configured to process information 310 relies at least in part upon hardware to achieve its functionality.

Referring to FIG. 3, the communication device 300 further includes logic configured to store information 315. In an example, the logic configured to store information 315 can include at least a non-transitory memory and associated hardware (e.g., a memory controller, etc.). For example, the non-transitory memory included in the logic configured to store information 315 can correspond to RAM, flash memory, ROM, erasable programmable ROM (EPROM), EEPROM, registers, hard disk, a removable disk, a CD-ROM, or any other form of storage medium known in the art. The logic configured to store information 315 can also include software that, when executed, permits the associated hardware of the logic configured to store information 315 to perform its storage function(s). However, the logic configured to store information 315 does not correspond to software alone, and the logic configured to store information 315 relies at least in part upon hardware to achieve its functionality.

Referring to FIG. 3, the communication device 300 further optionally includes logic configured to present information 320. In an example, the logic configured to present information 320 can include at least an output device and associated hardware. For example, the output device can include a video output device (e.g., a display screen, a port that can carry video information such as USB, HDMI, etc.), an audio output device (e.g., speakers, a port that can carry audio information such as a microphone jack, USB, HDMI, etc.), a vibration device and/or any other device by which information can be formatted for output or actually outputted by a user or operator of the communication device 300. For example, if the communication device 300 corresponds to the IoT device 200A as shown in FIG. 2A and/or the passive IoT device 200B as shown in FIG. 2B, the logic configured to present information 320 can include the display 226. In a further example, the logic configured to present information 320 can be omitted for certain communication devices, such as network communication devices that do not have a local user (e.g., network switches or routers, remote servers, etc.). The logic configured to present information 320 can also include software that, when executed, permits the associated hardware of the logic configured to present information 320 to perform its presentation function(s). However, the logic configured to present information 320 does not correspond to software alone, and the logic configured to present information 320 relies at least in part upon hardware to achieve its functionality.

Referring to FIG. 3, the communication device 300 further optionally includes logic configured to receive local user input 325. In an example, the logic configured to receive local user input 325 can include at least a user input device and associated hardware. For example, the user input device can include buttons, a touchscreen display, a keyboard, a camera, an audio input device (e.g., a microphone or a port that can carry audio information such as a microphone jack, etc.), and/or any other device by which information can be received from a user or operator of the communication device 300. For example, if the communication device 300 corresponds to the IoT device 200A as shown in FIG. 2A and/or the passive IoT device 200B as shown in FIG. 2B, the logic configured to receive local user input 325 can include the buttons 222, 224A, and 224B, the display 226 (if a touchscreen), etc. In a further example, the logic configured to receive local user input 325 can be omitted for certain communication devices, such as network communication devices that do not have a local user (e.g., network switches or routers, remote servers, etc.). The logic configured to receive local user input 325 can also include software that, when executed, permits the associated hardware of the logic configured to receive local user input 325 to perform its input reception function(s). However, the logic configured to receive local user input 325 does not correspond to software alone, and the logic configured to receive local user input 325 relies at least in part upon hardware to achieve its functionality.

Referring to FIG. 3, while the configured logics of 305 through 325 are shown as separate or distinct blocks in FIG. 3, it will be appreciated that the hardware and/or software by which the respective configured logic performs its functionality can overlap in part. For example, any software used to facilitate the functionality of the configured logics of 305 through 325 can be stored in the non-transitory memory associated with the logic configured to store information 315, such that the configured logics of 305 through 325 each performs their functionality (i.e., in this case, software execution) based in part upon the operation of software stored by the logic configured to store information 315. Likewise, hardware that is directly associated with one of the configured logics can be borrowed or used by other configured logics from time to time. For example, the processor of the logic configured to process information 310 can format data into an appropriate format before being transmitted by the logic configured to receive and/or transmit information 305, such that the logic configured to receive and/or transmit information 305 performs its functionality (i.e., in this case, transmission of data) based in part upon the operation of hardware (i.e., the processor) associated with the logic configured to process information 310.

Generally, unless stated otherwise explicitly, the phrase “logic configured to” as used throughout this disclosure is intended to invoke an aspect that is at least partially implemented with hardware, and is not intended to map to software-only implementations that are independent of hardware. Also, it will be appreciated that the configured logic or “logic configured to” in the various blocks are not limited to specific logic gates or elements, but generally refer to the ability to perform the functionality described herein (either via hardware or a combination of hardware and software). Thus, the configured logics or “logic configured to” as illustrated in the various blocks are not necessarily implemented as logic gates or logic elements despite sharing the word “logic.” Other interactions or cooperation between the logic in the various blocks will become clear to one of ordinary skill in the art from a review of the aspects described below in more detail.

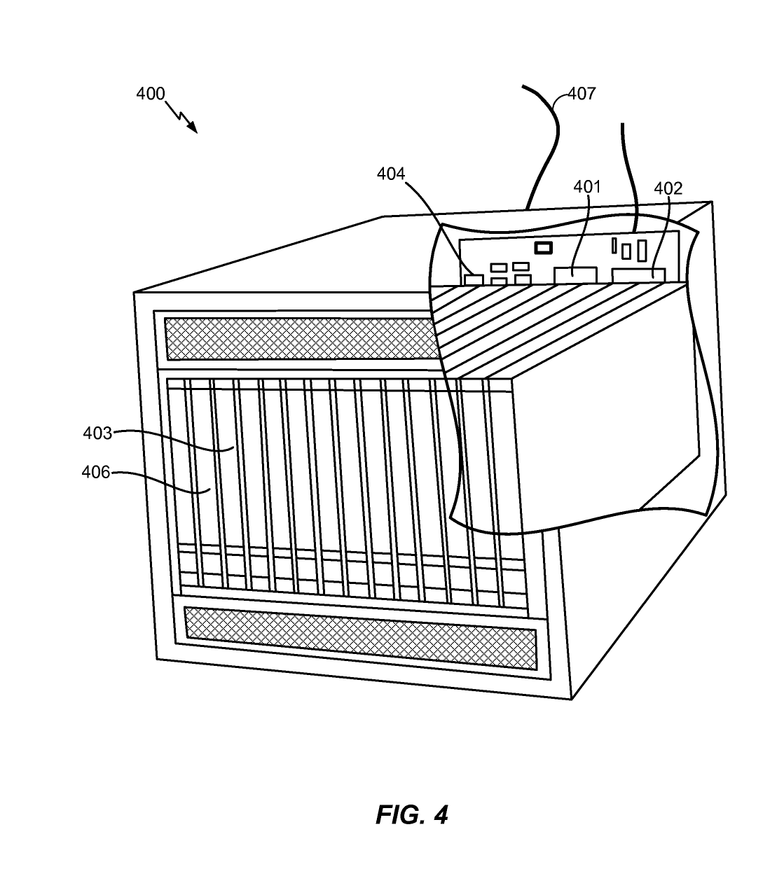

The various embodiments may be implemented on any of a variety of commercially available server devices, such as server 400 illustrated in FIG. 4. In an example, the server 400 may correspond to one example configuration of the IoT server 170 described above. In FIG. 4, the server 400 includes a processor 401 coupled to volatile memory 402 and a large capacity nonvolatile memory, such as a disk drive 403. The server 400 may also include a floppy disc drive, compact disc (CD) or DVD disc drive 406 coupled to the processor 401. The server 400 may also include network access ports 404 coupled to the processor 401 for establishing data connections with a network 407, such as a local area network coupled to other broadcast system computers and servers or to the Internet. In context with FIG. 3, it will be appreciated that the server 400 of FIG. 4 illustrates one example implementation of the communication device 300, whereby the logic configured to receive and/or transmit information 305 corresponds to the network access points 404 used by the server 400 to communicate with the network 407, the logic configured to process information 310 corresponds to the processor 401, and the logic configuration to store information 315 corresponds to any combination of the volatile memory 402, the disk drive 403 and/or the disc drive 406. The optional logic configured to present information 320 and the optional logic configured to receive local user input 325 are not shown explicitly in FIG. 4 and may or may not be included therein. Thus, FIG. 4 helps to demonstrate that the communication device 300 may be implemented as a server, in addition to an IoT device implementation as in FIG. 2A.

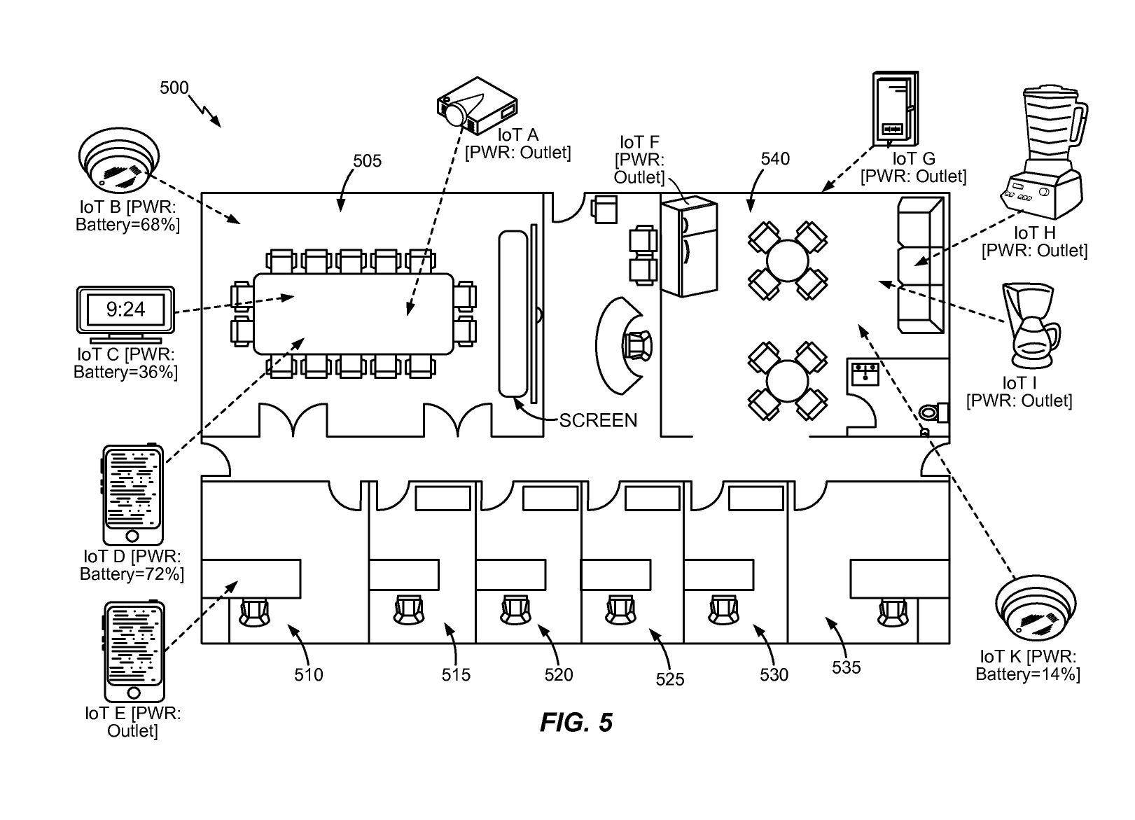

FIG. 5 illustrates an example of an IoT environment (or distributed IoT network) 500 in accordance with an embodiment of the invention. In FIG. 5, the IoT environment 500 is an office space with a conference room 505, a plurality of offices 510 through 535 and a kitchen 540. Within the office space, IoT device A (e.g., a video projector), IoT device B (e.g., a smoke detector), IoT device C (e.g., an alarm clock) and IoT device D (e.g., a handset device such as a cell phone or tablet computer) are positioned in conference room 505, and IoT device E (e.g., a handset device such as a cell phone or tablet computer) is positioned in office 510. Also, IoT device F (e.g., a refrigerator), IoT device G (e.g., a thermostat), IoT device H (e.g., a blender), IoT device I (e.g., a coffee maker) and IoT device K (e.g., a smoke detector) are positioned in the kitchen 540. As will be appreciated, while the IoT environment 500 of FIG. 5 is directed to an office, many other configurations of IoT environments are also possible (e.g., residential homes, retail stores, vehicles, stadiums, etc.).

Also shown in FIG. 5 is the associated power status for each of IoT devices A...K. For example, IoT devices A, E, G, H and I are plugged into an outlet, whereas IoT devices B, C, D and K are battery-powered only (not outlet-connected) and have various degrees of battery power. While not shown explicitly in FIG. 5, the power status can be more nuanced than a mere indication of whether an IoT device is battery-powered or outlet-powered (i.e., plugged-in). For example, the refrigerator (IoT device F) and thermostat (IoE device G) may be plugged into an outlet at all times (e.g., to reduce freezer defrosting, to maintain temperature/humidity conditions at all times, etc.) whereas IoT devices E, G, H and I may be plugged in currently but only intermittently (e.g., IoT device E may be a mobile device that is currently charging but historically goes through periods of operation where it is not plugged in, IoT Devices G, H and I may be shutoff or outlet-disconnected during non-work hours to conserve electricity, etc.).

Certain IoT devices may be mobile, in which case a user may misplace or forget where he/she placed one or more mobile IoT devices from time to time. It is generally difficult to pinpoint the location of such mobile IoT devices at a granularity that would be relevant to a user searching for the devices within a particular IoT environment. For example, conventional solutions for identifying a lost IoT device (e.g., a cell phone, a tablet PC, etc.) include requesting that the “lost” IoT device emit a noise (e.g., a periodic beeping noise or other alert sound) that is detectable by the user from which the user can track down the device location, or to report a coarse location estimate such as a GPS location or a current WiFi hotspot or cell tower to which the lost IoT device is connected. However, the user may be out-of-range of the noise (or the IoT environment could simply be really loud) and the GPS location may only function to confirm that the lost device is in a particular IoT environment (as opposed to being stolen or otherwise off the premises) without providing much information on where the lost device is located within the IoT environment.

Embodiments of the invention are thereby directed to obtaining augmented location information (ALI) associated with nearby IoT devices that can be used to generate a location profile of a target IoT device, such as a lost IoT device from the above-noted examples. Unlike coarse location estimates (e.g., GPS location, WiFi hotspot or router identification, etc.), the ALI permits a user to ascertain where the target IoT device is located within a particular IoT environment, as will be explained below in more detail.

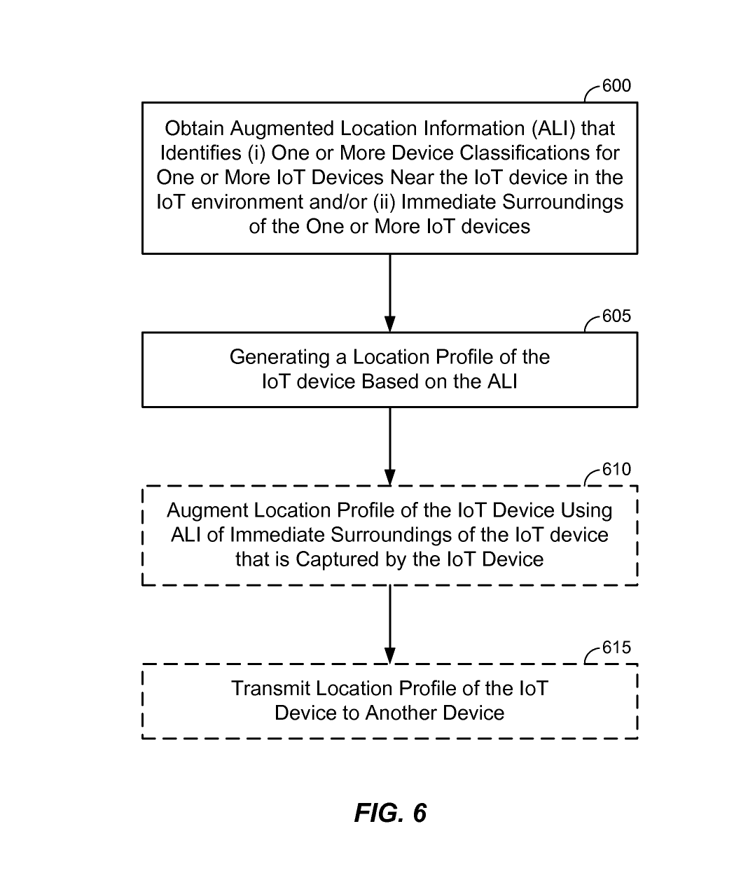

FIG. 6 illustrates a high-level process of generating a location profile of a given IoT device in accordance with an embodiment of the invention. Referring to FIG. 6, the given IoT device obtains augmented location information (ALI) related to one or more IoT devices near the given IoT device. The ALI related to the one or more IoT devices collectively identifies (i) one or more device classifications for the one or more IoT devices near the given IoT device in the IoT environment and/or (ii) immediate surroundings of the one or more IoT devices, 600. As used herein, the term “ALI” is used to individually refer to ALI that is obtained from each of the one or more IoT devices in a device-specific manner (e.g., the given IoT device obtains a first ALI for IoT device 1, a second ALI for IoT device 2, etc.). If the given IoT device obtains ALI related to multiple IoT devices, then the term “ALI” from the perspective of the given IoT device refers to an aggregation or accumulation of the ALI obtained from the multiple IoT devices. Thereby, depending on the context, “ALI” is used to refer either to a device-specific ALI, or an aggregation of device-specific ALIs.

As will be explained in more detail below, the device classifications can identify type(s) of the IoT devices and/or location-descriptive name(s) of the IoT devices and can be used to imply a location association (e.g., an IoT device classified as a geo-static refrigerator is likely to be in a kitchen, and a user is likely to know where the refrigerator and kitchen are located which will help the user to converge on the target IoT device). In another example, if a home has two refrigerators (one in the kitchen and one in the basement), a user can name these devices as “kitchen refrigerator” and “basement refrigerator”, and these location-descriptive device names can be made part of the respective ALIs for the two refrigerators, which will help the user to converge on a target IoT device's location. Also, as will be explained in more detail below, the immediate surroundings of the nearby IoT devices can be conveyed in a variety of ways, such as by having the nearby IoT devices snap photographs of their surroundings. In this example, when these photographs are sent to the user, the user may be able to converge on the location of the given IoT device based on recognition of a general area shown in the photographs, based on the target IoT device itself being shown as an object in the photographs (e.g., in which case the angle or orientation between the camera and the target IoT device can be used as part of the ALI), and so on. In another example, the immediate surroundings of the nearby IoT devices can be conveyed via an audio recording (e.g., the audio recording may record a recognizable sound, such as a drying machine executing a dry cycle, which the user can use to converge on the location of the target IoT device).

After obtaining the ALI at 600, the given IoT device generates a location profile of the given IoT device based on the ALI, 605. In an example, the location profile can be generated at 605 simply by aggregating all of the ALI obtained at 600. In an alternative example, the given IoT device can apply one or more filtering rules to the ALI obtained at 600 so that a filtered version of the ALI obtained at 600 is populated within the location profile in order to increase a relevance of the information contained in the location profile. Accordingly, some or all of the ALI obtained at 600 may be populated within the location profile.

The given IoT device can also optionally augment the location profile of the given IoT device based on ALI captured by the given IoT device itself relevant to the given IoT device's immediate surroundings, 610. For example, in addition to populating the location profile with one or more images captured by nearby IoT devices, the given IoT device could also populate the location profile with its own captured image assuming the given IoT device had image capture capability (e.g., the given IoT device takes a picture that shows a landmark, and this picture can be sent to another device so that the given IoT device can be recognized as being close to the landmark and potentially a camera angle or orientation of the landmark can be used to further pinpoint the given IoT device's relative location). Also, the given IoT device can optionally transmit the location profile to another device, 615. For example, in a scenario where the given IoT device is misplaced by a user and the user is trying to track down the location of the given IoT device, the location profile can be transmitted to another device being operated by the user at 615. In another example, in a scenario where the given IoT device is operated by a child and a parent is trying to track down the location of his/her child, the location profile can be transmitted to another device being operated by the parent at 615, and so on.

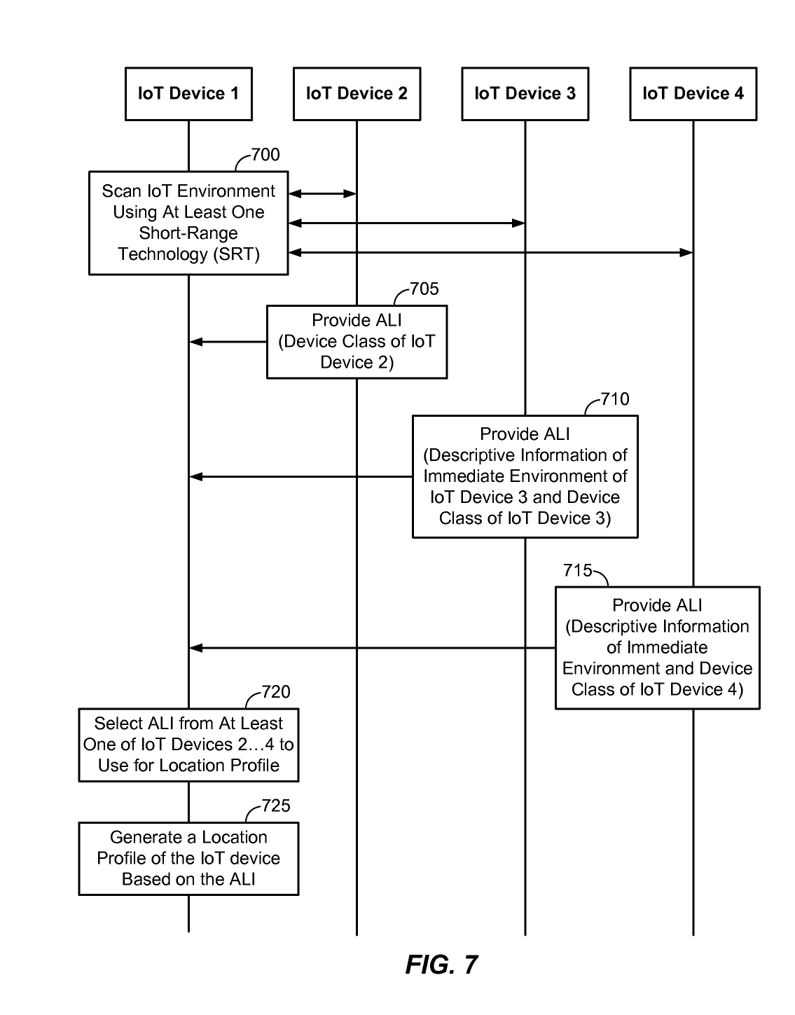

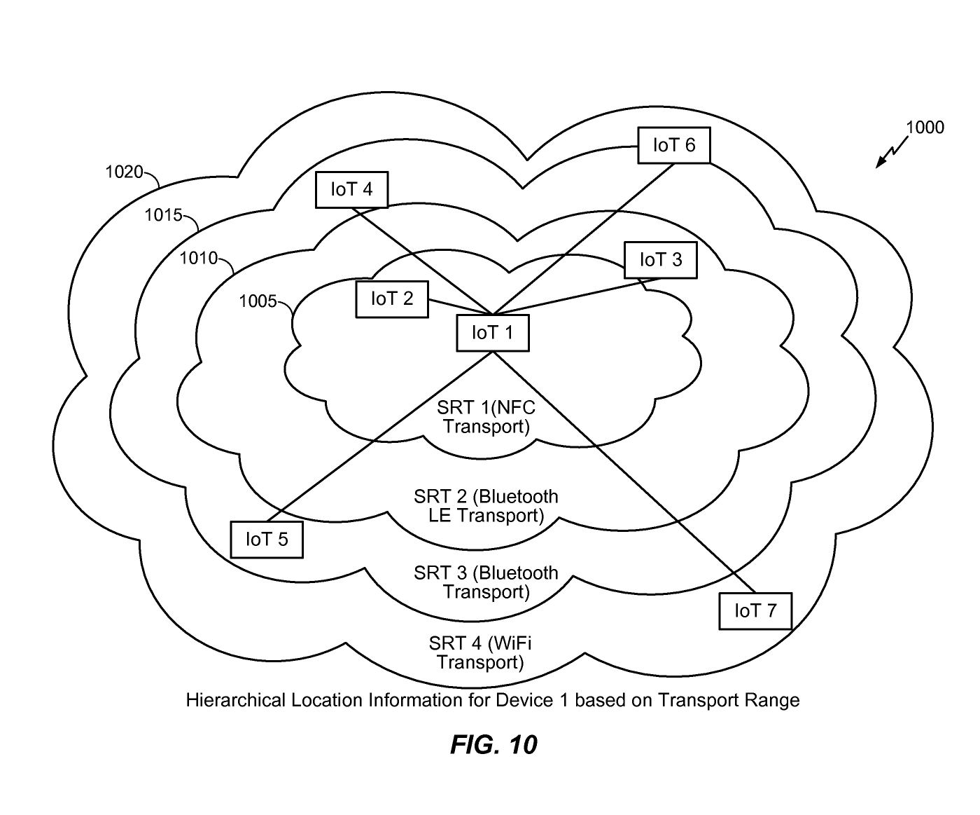

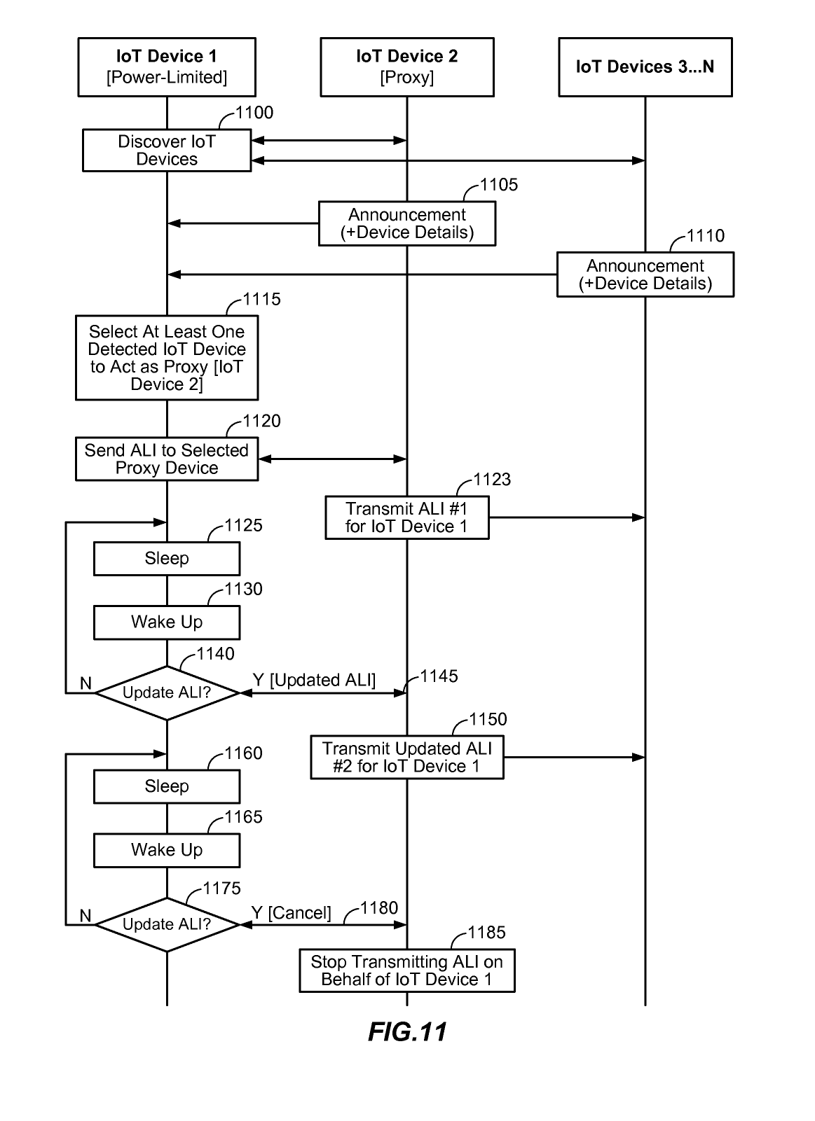

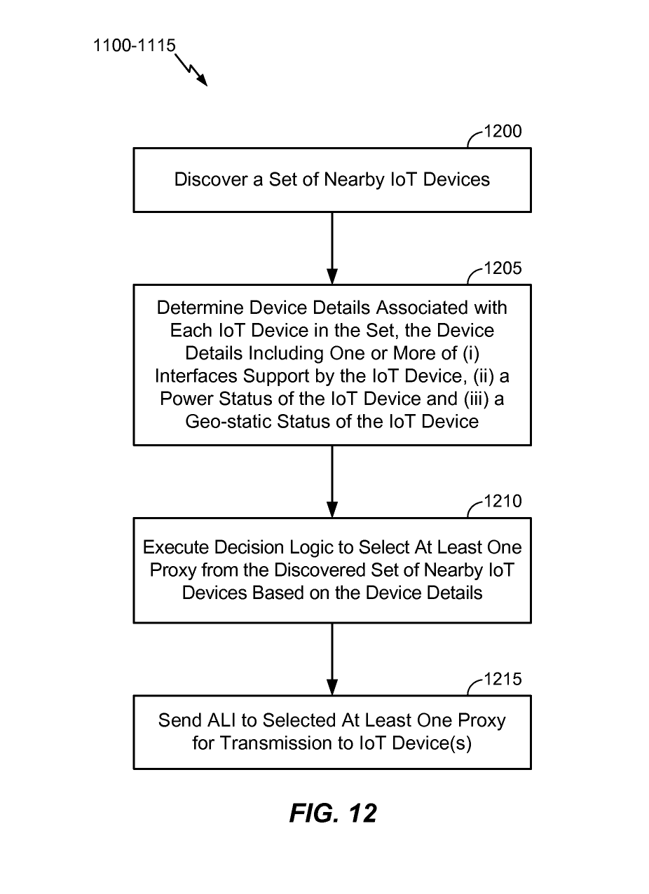

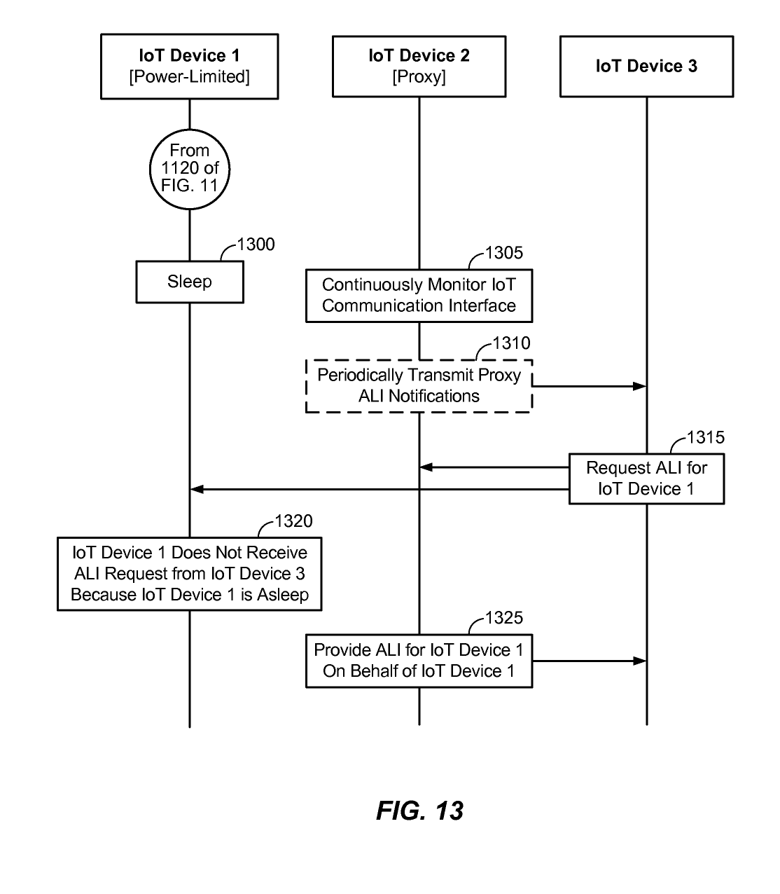

FIG. 7 illustrates an example implementation of the process of FIG. 6 in accordance with an embodiment of the invention. In particular, in FIG. 7, the process of FIG. 6 is performed by IoT device 1. Referring to FIG. 7, IoT device 1 scans an IoT environment, such as the IoT environment 500 from FIG. 5, using at least one short-range technology (SRT), 700. The at least one SRT can correspond to a number of different SRT types, including but not limited to Near Field Communication (NFC) Transport, Bluetooth Low Energy (LE) Transport, Bluetooth Transport and WiFi Transport. The scanning of 700 can be implemented in a variety of ways, such as via an iterative scanning process that starts by scanning with a lowest-range SRT and then successively scans with longer-range SRTs until sufficient ALI is obtained, as will be described below in more detail with respect to FIGS. 9-10. Alternatively, the scanning of 700 can select an appropriate target SRT based on an operating environment of IoT device 1 (e.g., pick Bluetooth if operating in a car, pick WiFi if operating in a house, etc.). In a further example, the scanning for devices could be achieved by listening to broadcast discovery information sent out by nearby devices over one or more communication mediums (e.g. listening for device advertisement messages sent out over Bluetooth or WiFi).

In response to the scanning of 700, IoT devices 2 . . . 4 deliver ALI to IoT devices over an IoT communications interface (e.g., WiFi, Bluetooth, etc.) at 705, 710 and 715, respectively. The IoT communications interface used to provide ALI at 705 through 715 will generally correspond to the SRT by which the respective IoT device was first contacted via the scanning of 700. So, if IoT device 2 is within Bluetooth range of IoT device 1 and was first contacted by IoT device 1 via Bluetooth, IoT device 2 can send its ALI to IoT device 1 via Bluetooth at 705 in an example. In an example, the IoT communications interface used to provide ALI at 705 through 715 can correspond to the SRT by which the respective IoT device was first contacted via the scanning of 700 based on IoT device 1 issuing requests for the ALI from the respective IoT device(s) over the corresponding SRT(s) where the respective IoT device(s) were discovered. These requests can be transmitted by IoT device 1 in association with the scanning of 700 in an example.

In the embodiment of FIG. 7, the ALI provided by IoT device 2 at 705 identifies a device classification of IoT device 2, the ALI provided by IoT device 3 at 710 identifies both a device classification of IoT device 3 as well as descriptive information of an immediate environment (or immediate surroundings) of IoT device 3, and the ALI provided by IoT device 4 at 715 identifies both a device classification of IoT device 4 as well as descriptive information of an immediate environment (or immediate surroundings) of IoT device 4. For example, the ALI for IoT device 2 may identify IoT device 2 as being a television, the ALI for IoT device 3 may identify IoT device 3 as a garage security camera and include a picture that is contemporaneously captured by IoT device 3 (e.g., in response to a request from IoT device 1 in conjunction with the scanning of 700) and the ALI for IoT device 4 may identify IoT device 4 as a phone.

At 720, IoT device 1 selects the ALI from some or all of IoT devices 2 . . . N to populate within its location profile. After selecting the ALI at 720, IoT device generates the location profile by populating the selected ALI within the location profile, 725. While not shown explicitly in FIG. 7, it will be appreciated that IoT device 1 may also optionally populate the location profile with information captured by IoT device 1 itself (e.g., a photograph, etc.) as in 610 of FIG. 6, and IoT device 1 may also optionally transmit the location profile to another device after generation as in 615 of FIG. 6 (e.g., such as to a parent device that is seeking his/her child whereby IoT device 1 is operated by the child, to a user that misplaced IoT device 1, and so on). Further, certain data added to the ALI can be enhanced from its corresponding source data. For example, a photograph showing IoT device 1 can be analyzed so as to report an associated camera angle or orientation between the camera and IoT device 1, from which IoT device 1 can be inferred as being located in a particular position relative to the camera (e.g., to the left or the right of the camera). In this case, the photograph itself can be included, or the relative location description can be reported (e.g., “your phone is located 10 feet to the left of the camera”), or both.

Generally, some ALI may be deemed to be more relevant (or to have a higher priority) than other ALI, and the selection of 720 may opt to select the more relevant ALI for inclusion within the location profile. For example, detection of a nearby IoT device with a “geo-static” device classification will generally be more relevant than a detection of a nearby “mobile” IoT device. As used herein, a geo-static IoT device refers to an IoT device that is expected to permanently or semi-permanently remain at its current position within the IoT environment. For example, a refrigerator is probably geo-static while a mobile phone is probably not geo-static, because refrigerators likely move within the IoT environment much less frequently than mobile phones. Thereby, knowledge that IoT device 1 is close to a geo-static IoT device is more likely to be relevant to ascertaining a current location of IoT device 1 as compared with knowledge that IoT device 1 is close to a mobile IoT device. However, a geo-static IoT device that is far away from IoT device 1 (e.g., only reachable via WiFi and not Bluetooth) may have less relevance than a closer mobile IoT device (e.g., reachable by Bluetooth or NFC). Also, if a nearby IoT device has the capability to take a contemporaneous photograph of its surroundings (or gather other types of contemporaneous data), the photograph itself may be highly relevant towards conveying a location of IoT device 1 irrespective of whether the device classification of the nearby IoT device is mobile or geo-static.

Accordingly, the selection of 720 can weigh a set of factors for its decision on which ALI to populate within the location profile for IoT device 1 at 720. This set of factors can include, for a corresponding nearby IoT device providing particular ALI, (i) whether the corresponding nearby IoT device is geo-static (e.g., refrigerator, oven, television, master bedroom lamp, family room television or family room photo frame, etc.) or non-geo-static (e.g., phone, iPad, kindle, etc.), (ii) whether the corresponding nearby IoT device is not geo-static but provides contemporaneous information related to its immediate environment (e.g., a picture or photograph, etc.), (iii) whether the corresponding nearby IoT device is non-geo-static but is expected to be easy to locate (e.g., a vehicle Bluetooth controller, whereby the vehicle is mobile but the user would normally be expected to know where his/her vehicle is located), (iv) a transport mechanism through which the corresponding nearby IoT device is reachable (e.g., a refrigerator reachable via Bluetooth indicates the given IoT device is in the kitchen, whereas a television reachable via WiFi is less relevant because the given IoT device is likely to be farther away from the television) and/or a (v) quality of the ALI (e.g., the ALI may correspond to a photograph, but if the room is dark, the photograph may be excluded from the location profile due to its poor quality).

Table 1 (below) shows an example generation of the location profile based on different types of ALI provided from nearby IoT Devices X, Y and Z. In Table 1, each enumerated example on each row is independent of each other, such the respective IoT Devices X, Y and Z vary from example to example such that Example #1 is not necessarily related (or correlated with) Example #2, and so on.

TABLE 1
Location Profile Generation Examples

| | | | | Location Profile of IoT |
|---|---|---|---|---|
| Example # | IoT Device X | IoT Device Y | IoT Device Z | Device 1 |
| 1 | ALI received | ALI received | ALI received | Photograph from IoT |
| | via WiFi; | via Bluetooth | via Bluetooth; | Device Y, and |
| | Device Class = | LE; | Device Class = | Identification of IoT |
| | Mobile Phone | Device Class = | Geo-Static | Device Z as Geo- |
| | | Geo-Static | Refrigerator | Static Refrigerator |
| | | Family Room | | |
| | | TV | | |
| | | Descriptive | | |
| | | Information = | | |
| | | Photograph | | |
| 2 | ALI received | ALI received | ALI received | Photograph from IoT |
| | via Bluetooth | via WiFi; | via Bluetooth; | Device X, and |
| | LE; | Device Class = | Device Class = | Identification of IoT |
| | Device Class = | Geo-Static | Geo-Static | Device Z as Geo- |
| | Mobile Phone; | Master | Refrigerator | Static Refrigerator |
| | Descriptive | Bedroom Lamp | | |
| | Information = | | | |
| | Photograph | | | |
| 3 | ALI received | ALI received | ALI received | Identification of IoT |
| | via WiFi; | via WiFi; | via Bluetooth; | Device Z as Geo- |
| | Device Class = | Device Class = | Device Class = | Static Refrigerator |
| | Mobile Phone | Geo-Static | Geo-Static | |
| | | Master | Refrigerator | |
| | | Bedroom Lamp | | |
| 4 | ALI received | ALI received | ALI received | Identification of IoT |
| | via WiFi; | via WiFi; | via Bluetooth; | Device Z as Car |
| | Device Class = | Device Class = | Device Class = Car | |
| | Mobile Phone | Geo-Static | | |
| | | Master | | |
| | | Bedroom Lamp | | |

As shown in Table 1 (above), in example #1, IoT device X provides a device classification of “mobile phone” via WiFi, IoT device Y provides a device classification of “geo-static Family Room TV” along with a photograph via Bluetooth LE, IoT device Z provides a device classification of “geo-static refrigerator” via Bluetooth, and the location profile for IoT device 1 includes the photograph from IoT device Y and the identification of IoT device Z as a geo-static refrigerator. In this case, IoT device X's device classification of “mobile phone” is omitted because WiFi has a wider coverage area than Bluetooth LE or Bluetooth and mobile phones are not geo-static, so IoT device X's ALI is less reliable or helpful as compared to the ALI from IoT devices Y or Z.

In example #2 from Table 1 (above), IoT device X provides a device classification of “mobile phone” via Bluetooth LE and also includes a photograph taken by the mobile phone at its current location (e.g., a contemporaneous photograph), IoT device Y provides a device classification of “geo-static master bedroom lamp” via WiFi, IoT device Z provides a device classification of “geo-static refrigerator” via Bluetooth, and the location profile for IoT device 1 includes the photograph from IoT device X and the identification of IoT device Z as a geo-static refrigerator. In this case, IoT device Y's device classification of “geo-static master bedroom lamp” is omitted because WiFi has a wider coverage area than Bluetooth LE or Bluetooth and a closer geo-static reference point is available (i.e., the geo-static refrigerator or IoT device Z), so IoT device Y's ALI is less reliable or helpful as compared to the ALI from IoT devices X or Z.

In example #3 from Table 1 (above), IoT device X provides a device classification of “mobile phone” via WiFi, IoT device Y provides a device classification of “geo-static master bedroom lamp” via WiFi, IoT device Z provides a device classification of “geo-static refrigerator” via Bluetooth, and the location profile for IoT device 1 includes the identification of IoT device Z as a geo-static refrigerator. In this case, IoT device X's device classification as a “mobile phone” is omitted both because it is geo-static and received over WiFi, and IoT device Y's device classification of “geo-static master bedroom lamp” is omitted because WiFi has a wider coverage area than Bluetooth and a closer geo-static reference point is available (i.e., the geo-static refrigerator or IoT device Z), so IoT device X and Y's ALI is less reliable or helpful as compared to the ALI from IoT device Z.

In example #4 from Table 1 (above), IoT device X provides a device classification of “mobile phone” via WiFi, IoT device Y provides a device classification of “geo-static master bedroom lamp” via WiFi, IoT device Z provides a device classification of “car” via Bluetooth, and the location profile for IoT device 1 includes the identification of IoT device Z as a car. In this case, IoT device X's device classification as a “ mobile phone” is omitted both because it is not geo-static and received over WiFi, and IoT device Y's device classification of “geo-static master bedroom lamp” is omitted because WiFi has a wider coverage area than Bluetooth. In this case, even though a car is not geo-static, the car is easy for users to recognize and acts as a good reference point, so IoT device X and Y's ALI is less reliable or helpful as compared to the ALI from IoT device Z.

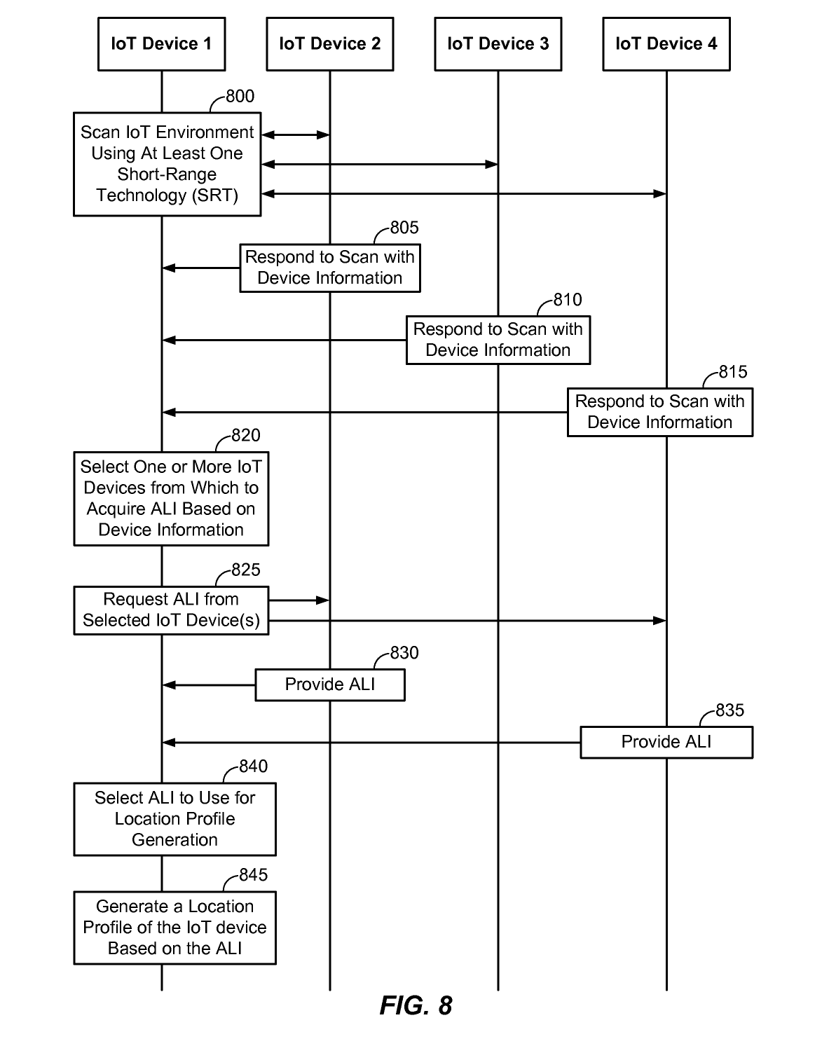

While FIG. 7 illustrates an example whereby ALI is received from multiple nearby IoT devices and then filtered, it is also possible that the nearby IoT devices can be discovered and then filtered based on various criteria, such that only certain IoT devices are selected to provide ALI. In other words, ALI can be received from various nearby IoT devices and then filtered (i.e., FIG. 7), or the nearby IoT devices can first be filtered and then targeted for more selectively requesting ALI (i.e., FIG. 8). Of course, a combination of these implementations is also possible whereby the nearby IoT devices are filtered or screened before requesting ALI, and the ALI received thereafter is separately filtered or screened before being populated within the location profile. Generally, the criteria by which the nearby IoT devices are selected to provide ALI is similar to how ALI can be selected at 720 of FIG. 7.

Referring to FIG. 8, IoT device 1 scans an IoT environment, such as the IoT environment 500 from FIG. 5, using at least one short-range technology (SRT), 800. The at least one SRT can correspond to a number of different SRT types, including but not limited to Near Field Communication (NFC) Transport, Bluetooth Low Energy (LE) Transport, Bluetooth Transport and WiFi Transport. The scanning of 800 can be implemented in a variety of ways, such as via an iterative scanning process that starts by scanning with a lowest-range SRT and then successively scans with longer-range SRTs until sufficient ALI is obtained, as will be described below in more detail with respect to FIGS. 9-10.

In response to the scanning of 800, IoT devices 2...4 send device information characterizing IoT devices 2 . . . 4 to IoT device 1 over an IoT communications interface (e.g., WiFi, Bluetooth, etc.) at 805, 810 and 815, respectively. The scanning of IoT devices could be achieved over broadcast, multicast and/or unicast e.g. scanning for devices could be sent out as multicast and the response from nearby devices could be sent out as unicast to IoT device 1. The IoT communications interface used to provide ALI at 805 through 815 will generally correspond to the SRT by which the respective IoT device was first contacted via the scanning of 800. So, if IoT device 2 is within Bluetooth range of IoT device 1 and was first contacted by IoT device 1 via Bluetooth, IoT device 2 can send its ALI to IoT device 1 via Bluetooth at 805 in an example.

In the embodiment of FIG. 8, the device information delivered to IoT device 1 at 805, 810 and 815 can include the device classifications described above with respect to FIG. 7 (e.g., “mobile phone”, “geo-static refrigerator”, etc.), in which case some or all of the device information can qualify as ALI. The device information can further include device capability information, such as the ability of a particular IoT device to capture a photograph of its surroundings.

At 820, IoT device selects one or more IoT devices from which to acquire ALI based on the device information received at 805, 810 and 815. As noted above, the device information can already include some ALI such as device classification, so the selection at 820 can be interpreted as a selection of IoT devices from which to request additional ALI in certain scenarios. For example, a security camera reachable via WiFi may be omitted from selection at 820 if a geo-static device with a camera is available over a shorter-range SRT is available, and so on. Generally, the same type of considerations as discussed above with respect to 720 are also relevant to the selection of 820, except 720 relates to filtering ALI already received at IoT device 1 and 820 relates to filtering IoT devices from which to request ALI.

After selecting the one or more IoT devices at 820, IoT device 1 requests ALI from the selected one or more IoT devices, 825. The ALI requested at 825 can be referred to as targeted ALI, as the ALI is being requested in a more targeted manner relative to the process of FIG. 7. In FIG. 7, IoT discovered IoT devices provide their ALI to IoT device 1 in response to a scanning beacon or signal sent during 700, whereas IoT device 1 selects the individual IoT devices from which to request the targeted ALI from among the discovered IoT devices in FIG. 8. In the embodiment of FIG. 8, assume that IoT devices 2 and 4 are selected at 820. In an example, IoT device 3 may be omitted from selection either because its ALI is deemed to have low relevance (e.g., IoT device 3 is a WiFi-connected mobile phone without camera capability) or sufficient ALI is already obtained (e.g., IoT device 3 is a Bluetooth LE-connected geo-static refrigerator). In an alternative example, the selection of 820 may not need to make any selection. For example, if IoT device 3 reports itself to be a Bluetooth LE-connected geo-static microwave at 810, this alone may be sufficient ALI to populate within the location profile in which case additional ALI gathering can be skipped. The IoT communications interface used to deliver the request at 825 can correspond to the IoT communications interface on which the device information is received at 805 and 815 in an example (e.g., Bluetooth LE, Bluetooth, etc.) and can be different for different of the selected IoT devices.

In the embodiment of FIG. 8, IoT devices 2 and 4 provide the requested ALI at 830 and 835, IoT device selects the ALI to use for location profile generation, 840 (e.g., similar to 720 of FIG. 7). After selecting the ALI at 840, IoT device generates the location profile by populating the selected ALI within the location profile, 845 (e.g., similar to 725 of FIG. 7). While not shown explicitly in FIG. 8, it will be appreciated that IoT device 1 may also optionally populate the location profile with information captured by IoT device 1 itself (e.g., a photograph, etc.) as in 610 of FIG. 6, and IoT device 1 may also optionally transmit the location profile to another device after generation as in 615 of FIG. 6 (e.g., such as to a parent device that is seeking his/her child whereby IoT device 1 is operated by the child, to a user that misplaced IoT device 1, and so on).

FIG. 9 illustrates an example implementation of IoT environment scanning in accordance with an embodiment of the invention. The IoT environment scanning described with respect to FIG. 9 can be used in conjunction with 700 of FIG. 7 or 800 of FIG. 8 in an example.

Referring to FIG. 9, IoT device 1 determines to start a location determination procedure at 900. The determination of 900 can be triggered by an external device attempting to pinpoint IoT device 1's location (e.g., a wife is looking for her husband in a shopping mall and pings the husband's IoT device to ascertain its current location in the shopping mall, an individual has lost his/her IoT device and sends a ping to the “lost” IoT device to figure out its current location, etc.).

After determining to start the location determination procedure at 900, IoT device 1 selects a first SRT to use for discovery of nearby IoT devices within an IoT environment, 905. In an example, the first SRT can be selected based at least in part upon an operating environment of IoT device 1. For example, if IoT device 1 is located in a car, the first SRT may correspond to Bluetooth, whereas if IoT device is located in a shopping mall the first SRT may correspond to WiFi. So, the first SRT does not necessarily correspond to the SRT with the shortest absolute range (although this is certainly possible), but could rather instead be environmentally selected.

In another example, the first SRT can simply correspond to an SRT with the shortest effective range among available SRTs that are used as IoT communication interfaces within a respective IoT environment, although this need not be true in all implementations. As shown in FIG. 10, the first SRT can correspond to NFC Transport within the IoT environment 1000, whereby the first SRT has a first effective range 1005. IoT device 1 attempts to discover its nearby IoT devices using the first SRT, 910, and one or more IoT devices respond to the scanning with device information and/or ALI, 915. While not shown explicitly in FIG. 9, the ALI at 915 can be provided as a supplemental procedure to the discovery procedure or can be provided in conjunction with discovery procedure (e.g., within a response message to a discovery ping from IoT device 1 over the first SRT). At 920, IoT device 1 determines whether to expand its IoT environment scan to another higher-range SRT. If IoT device 1 determines its acquired ALI is sufficient to generate a location profile at 920, the process advances to 960 without attempting to scan with any additional SRTs. Alternatively, if IoT device 1 determines to attempt acquisition of additional ALI using one or more higher-range SRTs, the process advances to 925. The decision to expand the scan at 920 can be based on a number of factors, including operating environment for IoT device 1 (e.g. if IoT device 1 is located in a car, Bluetooth can be selected to scan for nearby devices without any scan expansion if the Bluetooth scan is unsuccessful, etc.). Another factor can include the quality of ALI already obtained over first SRT (e.g. if IoT device 1 has already received a geo-static ALI with a photograph, IoT device 1 may decide at 920 not to scan for devices over another SRT. On the other hand, if the ALI received does not provide sufficient location certainty, IoT device 1 may decide at 920 to continue scanning over other SRT communication mediums (e.g., if ALI received over first SRT such as Bluetooth indicates IoT device 1 is near a Bluetooth headset, IoT device 1 may decide to continue scanning over WiFi because a user may not know where the Bluetooth headset is located in his/her proximal environment). The above-noted factors can also be considered in context with subsequent scan expansion decisions (e.g., 940, etc.).

At 925, IoT device 1 selects a second SRT to use for discovery of nearby IoT devices within an IoT environment. As shown in FIG. 10, the second SRT can correspond to Bluetooth LE Transport within the IoT environment 1000, whereby the second SRT has a second effective range 1010 that extends farther than the first effective range 1005. In an example, the second SRT can correspond to an SRT with the second shortest effective range among available SRTs that are used as IoT communication interfaces within a respective IoT environment, although this need not be true in all implementations. IoT device 1 attempts to discover its nearby IoT devices using the second SRT, 930, and one or more IoT devices respond to the scanning with device information and/or ALI, 935. While not shown explicitly in FIG. 9, the ALI at 935 can be provided as a supplemental procedure to the discovery procedure or can be provided in conjunction with the discovery procedure (e.g., within a response message to a discovery ping from IoT device 1 over the second SRT). At 940, IoT device 1 determines whether to expand its IoT environment scan to another higher-range SRT. If IoT device 1 determines its acquired ALI is sufficient to generate a location profile at 940, the process advances to 960 without attempting to scan with any additional SRTs. Alternatively, if IoT device 1 determines to attempt acquisition of additional ALI using one or more higher-range SRTs, the process advances to 945.

At 945, IoT device 1 selects a third SRT to use for discovery of nearby IoT devices within an IoT environment. As shown in FIG. 10, the third SRT can correspond to Bluetooth Transport within the IoT environment 1000, whereby the third SRT has a third effective range 1015 that extends farther than the first effective range 1005 or the second effective range 1010. In an example, the third SRT can correspond to an SRT with the third shortest effective range among available SRTs that are used as IoT communication interfaces within a respective IoT environment, although this need not be true in all implementations. IoT device 1 attempts to discover its nearby IoT devices using the third SRT, 950, and one or more IoT devices respond to the scanning with device information and/or ALI, 955. While not shown explicitly in FIG. 9, the ALI at 955 can be provided as a supplemental procedure to the discovery procedure or can be provided in conjunction with the discovery procedure (e.g., within a response message to a discovery ping from IoT device 1 over the third SRT). While not shown explicitly in FIG. 9, the iterative scanning or discovery procedure of FIG. 9 can continue using more and more SRTs until sufficient ALI is acquired. For example, a fourth SRT (e.g., WiFi Transport as shown in FIG. 10 with effective range 1020) can be used after the third SRT, and so on. Also, while the embodiment of FIG. 9 is described whereby a single SRT is attempted per iteration, it is possible that two or more SRTs can be attempted in conjunction during any particular iteration (e.g., first attempt Bluetooth, then expand to WiFi while re-attempting Bluetooth, etc.).

After sufficient ALI is acquired for generation of the location profile, the IoT device 1 selects, from among its acquired ALI, ALI to be used within the location profile, 960 (e.g., similar to 720 of FIG. 7 and/or 840 of FIG. 8), and then generates the location profile with the selected ALI, 965. While not shown explicitly in FIG. 9, it will be appreciated that IoT device 1 may also optionally populate the location profile with information captured by IoT device 1 itself (e.g., a photograph, etc.) as in 610 of FIG. 6, and IoT device 1 may also optionally transmit the location profile to another device after generation as in 615 of FIG. 6 (e.g., such as to a parent device that is seeking his/her child whereby IoT device 1 is operated by the child, to a user that misplaced IoT device 1, and so on).

In the embodiments described above with respect to FIGS. 6-10, ALI for a particular IoT device is provided to another IoT device requesting the ALI by the particular IoT device itself. However, it is also possible that a “proxy” IoT device can provide ALI on behalf of a “power-limited” IoT device as will be described below in more detail with respect to FIGS. 11-13.

Conventionally, each IoT device in the IoT environment 500 would be individually responsible for continuously monitoring the IoT communications interface for incoming communications while also transmitting its own communications over the IoT communications interface, in part because any IoT device incapable of doing so would be assumed incapable of operating within the IoT environment 500 in any case. However, it will be appreciated that requiring each IoT device to continuously monitor the IoT communications interface and to transmit its own communications places a disproportionate burden on “power-limited” IoT devices in the IoT environment 500, as will now be explained.

As used herein, whether an IoT device is “power-limited” is a relative terminology that indicates that the power resources of one IoT device have a higher priority than the power resources of at least one other IoT device. Referring to FIG. 5 as an example, IoT device K has a battery level of 14% and may be more power limited than IoT device B with a battery level of 68%, such that IoT device K is more power limited than IoT device B. IoT device E is plugged into a power source (or outlet), but is expected to only be intermittently outlet-connected, such that IoT device E can be interpreted as being more power-limited than IoT device F due to IoT device F having a more reliable power supply, and so on. Also, even though IoT device C has a battery level of 36%, IoT device may have a slower power-consumption rate than IoT device D (e.g., because alarm clocks generally use a lower amount of power as compared to handset or tablet devices), such that IoT device D may be more power limited than IoT device C even though IoT device C has a lower battery level. Further, certain IoT devices are configured to provide more critical functions as compared to other IoT devices. If an alarm clock loses power an alarm might be missed, but if a smoke detector loses power then both lives and property may be put at risk. Thus, the smoke detector may be deemed more power limited than the alarm clock even when the smoke detector has more available power than the alarm clock.

Accordingly, embodiments of the invention are directed to a proxy ALI scheme whereby the function of providing ALI (“ALI reporting function”) on behalf of a power-limited IoT device is transferred, in whole or in part, to at least one other IoT device.

FIG. 11 illustrates a process by which a power-limited IoT device (“IoT device 1”) sets up another IoT device (“IoT device 2”) as a proxy for an ALI reporting function of the power-limited IoT device in accordance with an embodiment of the invention.

Referring to FIG. 11, IoT device 1 triggers discovery of a set of nearby IoT devices, 1100. The discovery of 1100 can be either passive (e.g., IoT device 1 monitors the IoT communications interface for messages from other IoT devices in the IoT network) or active (e.g., IoT device 1 can transmit a multicast discovery ping to solicit messages from nearby IoT devices). Irrespective of whether the discovery of 1100 is active or passive, IoT devices 2 . . . N each transmit an announcement message to IoT device 1 that includes device details associated with the transmitting IoT device, 1105 and 1110. The messages of 1105 and 1110 can be configured as multicast messages in an example, but for the sake of convenience the respective messages of 1105 and 1110 are shown as being delivered to IoT device 1 in FIG. 11. Examples of the device details that can be reported by the messages of 1105 and 1110 are described in more detail below with respect to FIG. 12. Based on the reported device details, IoT device 1 determines which devices are available for providing proxy functions e.g. based on interfaces supported by these devices. For example, if IoT device 1 is interesting in distributing its ALI via Bluetooth, IoT device 1 can attempt to filter out IoT devices that did not respond via Bluetooth at 1105 or 1110 (e.g., WiFi devices are excluded, etc.). Thus, the proxy for the ALI reporting function of IoT device 1 can be selected based at least in part upon a desired interface type (e.g., Bluetooth, WiFi, etc.) for the ALI reporting function.

Further, while not shown explicitly in FIG. 11, IoT device 1 may trigger the process of FIG. 11 in response to one or more triggering events. For example, IoT device 1 may perform the discovery procedure whenever it joins a new IoT network to determine if any IoT devices that are less power-limited than IoT device 1 can act as a proxy for IoT device 1. Alternatively, the process of FIG. 11 can be performed periodically (e.g., every half hour, etc.) because power statuses can be expected to change over time, especially for battery-powered IoT devices or intermittently plugged-in IoT devices. Alternatively, the process of FIG. 11 can be performed in response to a deteriorating power condition of IoT device 1 (e.g., whenever IoT device 1 has a battery level that drops below a certain percentage or is expected to run out before a certain time, if IoT device 1 is an intermittently plugged-in device that expects its power source to become less reliable in the near future, etc.). Alternatively, the process of FIG. 11 can be performed before an IoT device transitions to a sleep mode (e.g. to save its power).

Referring to FIG. 11, IoT device 1 detects IoT devices 2 . . . N based on the messages from 1105 and 1110, and then selects at least one of the detected IoT devices to act as a proxy for the ALI reporting function, 1115. As noted above, the detected IoT devices can be filtered by interface type, such that any detected IoT devices that do not support a desired interface type for the ALI reporting function are excluded from the selection of 1115. In the embodiment of FIG. 11, IoT device 1 is shown as selecting IoT device 2 for acting as the proxy for the ALI reporting function, but it will be appreciated that other embodiments can be directed to multiple IoT devices performing the ALI reporting function on behalf of IoT device 1.

After selecting IoT device 2 as the proxy for the ALI reporting function, IoT device 1 coordinates with IoT device 2 to act as the proxy, 1120. For example, IoT device 1 can instruct IoT device 2 with respect to how to configure an ALI message to be transmitted on behalf of IoT device 1 (e.g., it invokes a “SendALI (device ID, app ID, ALI msg ID, ALI message with proxy flag, TTL)” interface on the proxy device to send its ALI information, whereby the proxy flag indicates that the ALI information transmitted by the proxy should be marked as originated from a proxy as opposed to IoT device 1 itself). For example, IoT device 1 may provide ALI such as a device classification (e.g., “car”, “television”, “mobile phone”, “living room photo frame”, “basement smoke detector”, etc.) and/or information related to IoT device 1's immediate surroundings (e.g., a photograph captured by IoT device 1, or another IoT device in its surrounding etc.) to IoT device 2. IoT device 2 can be packaged ALI for IoT device 1 into a periodically transmitted ALI message in one example (e.g., containing the device classification, etc.), or alternatively could provide ALI information explicitly when requested. In a further example, IoT device 1 can provide IoT device 2 with a defined wake-up schedule (e.g., every 30 seconds for 1 seconds, etc.) so that IoT device 2 knows when to forward any incoming ALI related messages to IoT device 1, and can optionally provide filtering criteria to IoT device 2. This permits IoT device 1 to go to sleep between scheduled wake-up times in order to conserve power. As will be explained below in more detail, the filtering criteria specifies one or more filters that are used by the IoT device 2 to decide whether or not a particular message should be transmitted to IoT device 1. For example, if IoT device 4 sends a message that requests a current photograph captured by IoT device 1 and a photograph maintained at IoT device 2 as part of IoT device 1's ALI is too old, IoT device 2 may determine to ping IoT device 1 to obtain an updated photograph to provide to IoT device 4. In another example, if IoT device 5 sends a message that requests a current audio recording captured by IoT device 1 and an audio recording is not maintained at IoT device 2 at all, IoT device 2 may determine to ping IoT device 1 to obtain the audio recording in order to provide to IoT device 4. Alternatively in some cases, proxy IoT device 2 could provide answers on behalf of IoT device 1 based on ALI information it has received from IoT device 1. For example, if IoT device 4 sends a message that requests a photograph captured by IoT device 1 and a photograph maintained at IoT device 2 as part of IoT device 1's ALI is recent enough, IoT device 2 will provide that photograph to IoT device 4 indicating that the photograph is sent from a proxy device.

In the embodiment of FIG. 11, assume that the coordination of 1120 is successful and that IoT device 2 agrees to act as the proxy for IoT device 1. Accordingly, IoT device 2 begins to transmit an ALI message (“ALI #1”) on behalf of IoT device 1 on a periodic basis and/or in response to explicit ALI requests from other IoT devices, 1123. In the embodiment of FIG. 11, IoT device 2 can transmit ALI #1 =either until IoT device 2 is explicitly asked to stop transmitting ALI by IoT device 1, or until a TTL associated with ALI #1 is expired. Also, IoT device 1 is permitted to power off and goes to sleep, 1125. Periodically, IoT device 1 wakes up in accordance with its defined wake-up schedule, 1130. While awake, IoT device 1 determines whether to update its ALI at 1140 (e.g., if IoT device 1 takes a new photograph of its surroundings it can replace an older photograph being provided by IoT device 2 as IoT device 1's ALI). If IoT device 1 determines not to change ALI #1 at 1140, the process returns to 1125 and IoT device 1 goes back to sleep until a next wake-up period. At 1140, assume that if IoT device 1 decides to change ALI #1, such that IoT device 1 coordinates with IoT device 2 so that the ALI reporting function is transitioned from ALI #1 to ALI #2, 1145 and 1150. In the embodiment of FIG. 11, IoT device 2 can transmit ALI #2 either until it is explicitly asked to stop by IoT device 1, or until a TTL associated with ALI #2.

At some point after 1140, IoT device 1 is permitted to power off and go to sleep, 1160 (e.g., similar to 1125). Periodically, IoT device 1 wakes up in accordance with its wake-up schedule, 1165 (e g , similar to 1130), to determine whether any change to ALI #2 needs to be made, 1175. For example, IoT device 1 can decide whether to change ALI #2 to a different ALI message (e.g., if IoT device 1 takes a new photograph of its surroundings it can replace an older photograph being provided by IoT device 2 as IoT device 1's ALI), or to stop transmission of all ALI messages by IoT device 2 on behalf of IoT device 1 (e.g. if IoT Device 1 decides to remain awake because of its power status of being plugged in). If IoT device 1 determines not to change ALI #2 at 1175, the process returns to 1160 and IoT device 1 goes back to sleep until a next wake-up period. At 1175, assume that if IoT device 1 decides to cancel the ALI reporting function altogether. Therefore, at 1180, IoT device 1 negotiates with IoT device 2 in order to stop the ALI reporting function. Accordingly, at 1185, IoT device 2 stops transmitting ALI #2—and ceases the ALI reporting function for IoT device 1.

Referring to FIG. 11, a class of messages can be defined for IoT device 1 to interact with its selected proxy device(s). For example, message types can be defined as follows in one example for setting up the selected proxy device(s) to implement the ALI reporting function:
sendALI (device ID, app ID, ALI msg ID, ALI msg, TTL, transmission details);
deleteALI (device ID, app ID, ALI msg ID); and
replaceALI (device ID, app ID, old ALI msg ID, new ALI msg ID, ALI msg, TTL),
   whereby sendALI( ) is sent by IoT device 1 to IoT device 2 at 1120 to configure ALI #1, replaceALI( ) is sent by IoT device 1 to IoT device 2 at 1145 to configure ALI #2 and deleteALI( ) is sent by IoT device 1 to IoT device 2 at 1180 to cancel ALI #2. The sendALI( ) message-type can either include the proxy flag, or alternatively the proxy flag can be inserted by the selected proxy device(s) by themselves when transmitting the proxy ALI messages. Further, a message type can be defined as follows in one example for setting up the selected proxy device(s) to implement the ALI reporting function:
receiveALlrequest (filtering criteria[OPTIONAL], wake-up schedule, original device contact address)
   whereby receiveALlrequest is sent by IoT device 1 to IoT device 2 at 1120 to configure the ALI reporting function by specifying when ALI requests that arrive at IoT device 2 are to be delivered to IoT device 1 (e.g., if IoT device 4 requests a type of ALI that is not available at IoT device 2, then IoT device 2 may ping IoT device 1 to provide the requested ALI, etc.). While not shown explicitly in FIG. 11, the wake-up schedule can change over time, and need not be fixed. For example, if IoT device 1 establishes IoT device 2 as its proxy when the battery-level of IoT device 1 is 84%, the wake-up schedule can be initialized to a first level. However, as the battery level of IoT device 1 decreases, the wake-up scheduled can be modified to permit IoT device 1 to sleep for longer periods of time between wake-ups.

FIG. 12 illustrates a more detailed implementation of the proxy selection logic that executes during 1100-1115 of FIG. 11 in accordance with an embodiment of the invention. Referring to FIG. 12, IoT device 1 discovers the set of nearby IoT devices 2 . . . N, 1200 (e.g., similar to 1100-1100 of FIG. 11). At 1205, IoT device 1 determines device details associated with the set of nearby IoT devices 2 . . . N, 1205. The device details can include (i) Specifying whether ALI proxying functionality is supported by the set of nearby IoT devices 2 . . . N, (ii) a power status of one or more IoT devices in the set of nearby IoT devices 2 . . . N and/or (iii) a geo-static status of one or more IoT devices in the set of nearby IoT devices 2 . . . N. Aspect (i) pertains to whether or not particular IoT devices are configured to perform the ALI reporting function on behalf of other IoT devices. This can be done by advertising an ALI proxying functionality as part of device details. Also, it may be desired to support ALI reporting function via a given underlying interface (e.g., Bluetooth, WiFi, etc.), and any IoT device that does not support this interface cannot act as a proxy for the ALI reporting function. Aspect (ii) can be used to infer whether another IoT device is more or less power-limited than IoT device 1 which can be used as a factor in the proxy selection. Aspect (iii) can be used as an additional factor in the proxy selection, whereby the geo-static status indicates whether or not a particular IoT device is expected to permanently or semi-permanently remain within the IoT environment. For example, a refrigerator is probably geo-static while a mobile phone is probably not geo-static, because refrigerators likely enter or leave the IoT environment much less frequently than mobile phones.

After determining the device details in 1205, IoT device 1 executes decision logic for selecting at least one proxy from the discovered set of nearby IoT devices based on the device details, 1210. IoT device 1 then sends ALI to its selected at least one proxy for transmission to IoT devices in the IoT environment, 1215. The IoT device 1 could optionally specify transmission details via an optional “transmission details” field in the sendALI( )message to the selected proxy device that specifies how to transmit the ALI e.g., either as a periodically transmitted ALI message or in an on-demand manner, as part of 1215. Different proxy selection rules which can be executed at 1210 are described below in Table 2. In Table 2, assume that IoT device 1 has discovered proxy candidates #1 and #2 along with their associated device details, and is attempting to select one (or both) of these proxy candidates to act as a proxy for IoT device 1. In Table 2., the ALI reporting function is shortened to “ARF”:

TABLE 2
Examples of Proxy Selection Rules

| | | Selection |
|---|---|---|
| Ex. # | Device Details | Result |
| 1 | IoT Device 1: | Select Proxy |
| | Power Status: Battery-powered [80%] | Candidate |
| | Proxy Candidate #1: | #1 for ARF |
| | ARF[Y]; Power Status: Outlet connected | |
| | [intermittent] | |
| | Proxy Candidate #2: | |
| | ARF[N]; Power Status: N/A | |
| 2 | IoT Device 1: | Select Proxy |
| | Power Status: Battery-powered [80%] | Candidate |
| | Proxy Candidate #1: | #1 for ARF |
| | ARF[Y]; Power Status: Outlet-connected | |
| | [intermittent]; Geo-static[Y] | |
| | Proxy Candidate #2: | |
| | ARF[Y]; Power Status: Battery-powered [30%]; | |
| | Geo-static[N] | |
| 3 | IoT Device 1: | Select Proxy |
| | Power Status: Battery-powered [80%] | Candidate |
| | Proxy Candidate #1: | #2 for ARF |
| | ARF[Y]; Power Status: Outlet-connected | |
| | [intermittent]; Geo-static[Y] | |
| | Proxy Candidate #2: | |
| | ARF[Y]; Power Status: Battery-powered [90%]; | |
| | Geo-static[Y] | |
| 4 | IoT Device 1: | Redundantly |
| | Type: Smoke Detector | Select Proxy |
| | Power Status: Battery-powered [75%] | Candidates |
| | Proxy Candidate #1: | #1 and #2 |
| | Type: Alarm Clock | for ARF |
| | ARF[Y]; Power Status: Battery-powered [90%] | |
| | Proxy Candidate #2: | |
| | Type: Alarm Clock | |
| | ARF[Y]; Power Status: Battery-powered [60%] | |
| 5 | IoT Device 1: | Select Proxy |
| | Power Status: Battery-powered [40%] | Candidate |
| | Proxy Candidate #1: | #2 for ARF |
| | Distance to IoT Device 1: 22.3 meters | |
| | ARF[Y]; Power Status: Outlet-connected | |
| | [permanent] | |
| | Proxy Candidate #2: | |
| | Distance to IoT Device 1: 0.7 meters | |
| | ARF[Y]; Power Status: Outlet-connected | |
| | [permanent] | |
| 6 | IoT Device 1: | Redundantly |
| | Power Status: Battery-powered [40%] | Select Proxy |
| | Proxy Candidate #1: | Candidates |
| | Distance to IoT Device 1: 15.0 meters [North] | #1 and #2 |
| | ARF[Y]; Power Status: Outlet-connected | for ARF |
| | [permanent]; Geo-static[Y] | |
| | Proxy Candidate #2: | |
| | Distance to IoT Device 1: 15.0 meters [South] | |
| | ARF[Y]; Power Status: Outlet-connected | |
| | [permanent]; Geo-static[Y] | |

Referring to Table 2 (above), a number of different proxy selection rule examples are provided. In examples 1 and 2 from Table 2, a single IoT device that is less power-limited than IoT device 1, which supports the ALI reporting function and which (preferably) is geo-static is selected as the proxy. As shown in example 1 from Table 2, IoT device 1 is battery-powered at 80%, proxy candidate #1 supports the ALI reporting function while being intermittently outlet-connected and proxy candidate #2 does not support the ALI reporting function, so proxy candidate #1 is selected as the proxy. As shown in example 2 from Table 2, IoT device 1 is battery-powered at 80%, proxy candidate #1 is geo-static and supports the ALI reporting function while being intermittently outlet-connected, and proxy candidate #2 is not geo-static and supports the ALI reporting function while being battery powered at 30%, so proxy candidate #1 is selected as the proxy.

Referring to example 3 from Table 2, IoT device 1 is battery-powered at 80%, proxy candidate #1 is geo-static and supports the ALI reporting function while being intermittently outlet-connected, and proxy candidate #2 is geo-static and supports the ALI reporting function while being battery powered at 90%. In this case, proxy candidate #2 is selected to support the ALI reporting function. This selection can be made in part because proxy candidate #1 is intermittently outlet-connected while proxy candidate #2 is not outlet-connected but has access to a non-intermittent power source.

Referring to example 4 from Table 2, IoT device 1 is a high-priority smoke detector that is battery-powered at 75%, and proxy candidates #1 and #2 are each low-priority alarm clocks that each support the ALI reporting function. Proxy candidate #1 is battery-powered at 90% while proxy candidate #2 is battery-powered at 60%. In this example, proxy candidate #1 is selected to support the ALI reporting function because it has more battery power than IoT device 1. Also, proxy candidate #2 is redundantly selected to support the ALI reporting function due to the higher priority of smoke detectors over alarm clocks. In an example, the ALI reporting function can be interleaved between proxy candidates #1 and #2 so that ALI messages are transmitted by proxy candidates #1 and #2 in an alternating sequence to conserve power at proxy candidates #1 and #2.

Referring to example 5 from Table 2, IoT device 1 is battery-powered at 40%, and proxy candidates #1 and #2 each permanently outlet-connected and each support the ALI reporting function. In this scenario, the interface-support and power statuses of proxy candidates #1 and #2 are equal, so IoT device 1 can select between the respective proxy candidates #1 and #2 based on secondary criteria. In particular, assume that IoT device 1 determines that its distance to proxy candidate #1 is 22.3 meters while its distance to proxy candidate #2 is 0.7 meters. Under an assumption whereby a more proximate IoT device is expected to operate better as a proxy, proxy candidate #2 can be selected for supporting the ALI reporting function based on its closer proximity to IoT device 1. In an example, the proximity between IoT device 1 and any other IoT devices in the same IoT environment can be ascertained using sound chirps as described in U.S. Publication No. 2015/0029880, entitled “PROXIMITY DETECTION OF INTERNET OF THINGS (IoT) DEVICES USING SOUND CHIRPS”.

Referring to example 6 from Table 2, similar to example 5, IoT device 1 is battery-powered at 40%, and proxy candidates #1 and #2 are each geo-static, permanently outlet-connected and support the ALI reporting function. However, in example 6, IoT device 1 is able to determine that proxy candidates #1 and #2 are each 15.0 meters away from IoT device 1 in different directions (e.g., North and South). In this scenario, IoT device 1 can redundantly select both proxy candidates #1 and #2 to support the ALI reporting function. As will be appreciated, because proxy candidates #1 and #2 are spread apart from each other within the IoT environment, selecting both proxy candidates #1 and #2 as proxies can extend the effective range of IoT device 1 within the IoT environment.

FIG. 13 illustrates an example of an ALI reporting function being implemented by a proxy IoT device (“IoT device 2”) in accordance with an embodiment of the invention. Referring to FIG. 13, assume that 1100-1120 of FIG. 11 are performed whereby IoT device 2 is selected as the proxy IoT device for supporting an ALI reporting function on behalf of IoT device 1. After IoT device coordinates with IoT device 2 to setup IoT device 2 as the proxy, IoT device 1 goes to sleep, 1300, IoT device 2 continuously monitors the IoT communication interface to detect any messages that are targeted to IoT device 1 (e.g., such as requests for ALI), 1305. IoT device 2 optionally periodically transmits a proxy ALI message (e.g., ALI #1 or #2 from FIG. 11) with a proxy flag over the IoT communication interface, 1310. In an example, the (optional) proxy ALI messages transmitted at 1310 may include at least some (e.g., all of the ALI, all of the ALI except for high-bandwidth ALI such as captured media so that any high-bandwidth ALI is only sent in an on-demand manner instead of as a periodic broadcast, etc.) of the ALI for IoT device 1, such as a device classification of IoT device 1.

While IoT device 1 is still asleep, assume that IoT device 3 determines to contact IoT device 1 to request ALI related to IoT device 1. IoT device 3 thereby generates an ALI request based on the determination and transmits the ALI request over the IoT communication interface within the IoT environment via multicast/broadcast, 1315. In a first example, a target address for the ALI request of 1315 can correspond to an address (or identifier) of IoT device 1, whereby IoT device 2 is configured to intercept any ALI requests targeted to IoT device 1 via the monitoring from 1305. In a second example, the target address for the ALI request of 1315 can correspond to an address (or identifier) of IoT device 2 because IoT device 3 may recognize via the proxy flag from the proxy ALI message of 1310 that IoT device 2 is collecting ALI requests directed to IoT device 1 for delivery. In either case, assume that IoT device 2 receives the ALI request from 1315 due to the continuous monitoring from 1305, but IoT device 1 does not receive the ALI request because IoT device 1 is still asleep at this point, 1320. At 1325, IoT device 2 transmits the ALI for IoT device 1 to IoT device 3 in response to the request from 1315. As will be appreciated from a review of FIG. 13, 1315-1325 are optional for certain implementations. For example, in an implementation where optional step 1310 is performed such that ALI is provided within the proxy ALI messages from 1310, it may not be necessary for IoT devices to request “supplemental” ALI from the proxy. Alternatively, the proxy ALI messages from 1310 may include lower-bandwidth ALI (e.g., device classification information) whereas “supplemental” or on-demand ALI can include higher-bandwidth ALI (e.g., locally captured photographs, sound recordings, etc.). Because the ALI of 1325 is transmitted (or relayed) to IoT device 3 on behalf of IoT device 1 by IoT device 2, the ALI transmitted at 1325 constitutes a proxy-relayed ALI portion of the ALI that is obtained by IoT device 3. The proxy-relayed ALI portion can correspond to some or all of the ALI obtained by IoT device 3 during an ALI acquisition procedure as discussed above with respect to FIGS. 6-10 in an example.

Those skilled in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those skilled in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted to depart from the scope of the present disclosure.

The various illustrative logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration).

The methods, sequences and/or algorithms described in connection with the aspects disclosed herein may be embodied directly in hardware, in a software module executed by a processor, or in a combination of the two. A software module may reside in RAM, flash memory, ROM, EPROM, EEPROM, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in an IoT device. In the alternative, the processor and the storage medium may reside as discrete components in a user terminal.

In one or more exemplary aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, DSL, or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes CD, laser disc, optical disc, DVD, floppy disk and Blu-ray disc where disks usually reproduce data magnetically and/or optically with lasers. Combinations of the above should also be included within the scope of computer-readable media.

While the foregoing disclosure shows illustrative aspects of the disclosure, it should be noted that various changes and modifications could be made herein without departing from the scope of the disclosure as defined by the appended claims. The functions, steps and/or actions of the method claims in accordance with the aspects of the disclosure described herein need not be performed in any particular order. Furthermore, although elements of the disclosure may be described or claimed in the singular, the plural is contemplated unless limitation to the singular is explicitly stated.

What is claimed is:

1. A method of operating an Internet of Things (IoT) device within an IoT environment, comprising:
obtaining augmented location information (ALI) that identifies (i) one or more device classifications for one or more IoT devices near the IoT device in the IoT environment and/or (ii) immediate surroundings of the one or more IoT devices; and
generating a location profile of the IoT device based on the obtained ALI.

2. The method of claim 1, further comprising:
receiving a request for the location profile from an external device,
wherein the obtaining and the generating are performed in response to the received request; and
transmitting the location profile to the external device.

3. The method of claim 1, further comprising:
receiving device information associated with each of a plurality of nearby IoT devices;
evaluating, for each of the plurality of nearby IoT devices, the associated device information to determine whether to request targeted ALI from the nearby IoT device, wherein the associated device information that is evaluated includes (i) whether the nearby IoT device is geo-static or non-geo-static, (ii) whether the nearby IoT device is configured to provide contemporaneous information related to its immediate environment, (iii) whether the nearby IoT device is non-geo-static but is expected to be easy for a user to locate, and/or (iv) a transport mechanism through which the nearby IoT device is reachable by the IoT device;
selecting a subset of the plurality of nearby IoT devices based on the evaluation; and
requesting the targeted ALI from the selected subset,
wherein the obtaining obtains the obtained ALI in response to the requesting.

4. The method of claim 1, further comprising:
evaluating the obtained ALI from each of the one or more IoT devices to determine some or all of the obtained ALI to be populated within the location profile, wherein the obtained ALI is evaluated based on (i) whether the associated IoT device from which the obtained ALI is geo-static or non-geo-static, (ii) whether the obtained ALI corresponds to contemporaneous information related to an immediate environment of the associated IoT device from which the obtained ALI is obtained, (iii) whether the associated IoT device from which the obtained ALI is obtained is non-geo-static but is expected to be easy for a user to locate, (iv) a transport mechanism through which the associated IoT device from which the obtained ALI is obtained is reachable by the IoT device and/or (v) a quality of the obtained ALI,
wherein the generating populates some or all of the obtained ALI within the location profile based on the evaluating.

5. The method of claim 1,
wherein the obtained ALI identifies the one or more device classifications for the one or more IoT devices near the IoT device in the IoT environment,
wherein the obtaining includes:
searching for nearby IoT devices satisfying a given set of criteria using a first short-range technology with a first range;
repeating the searching using one or more short-range technologies with ranges that are longer than the first range if the nearby IoT devices satisfying the given set of criteria are not detected via the first short-range technology,
wherein the obtained ALI corresponds to an associated range of a given short-range technology that detects the nearby IoT devices satisfying the given set of criteria.

6. The method of claim 1, wherein the obtained ALI identifies the immediate surroundings of the one or more IoT devices.

7. The method of claim 6,
wherein the obtained ALI includes a photograph of the immediate surroundings of the one or more IoT devices and/or first information based on the photograph, or
wherein the obtained ALI includes an audio recording that captures sounds emitted in the immediate surroundings of the one or more IoT devices and/or second information based on the audio recording.

8. The method of claim 1, wherein the obtaining includes:
detecting an environmental characteristic of the IoT device,
selecting a short-range technology based on the detected environmental characteristic, and
searching for nearby IoT devices satisfying a given set of criteria using the selected short-range technology.

9. The method of claim 8,
wherein the environmental characteristic of the IoT device is a home environment, and
wherein the selected short-range technology is WiFi based on the IoT device being detected in the home environment.

10. The method of claim 8,
wherein the environmental characteristic of the IoT device is an in-vehicle environment, and
wherein the selected short-range technology is Bluetooth based on the IoT device being detected in the in-vehicle environment.

11. The method of claim 1, wherein the obtained ALI includes a proxy-relayed ALI portion for a given IoT device that is obtained from a proxy IoT device that is configured to provide the proxy-relayed ALI portion of the obtained ALI on behalf of the given IoT device as part of a power-conservation scheme.

12. The method of claim 11,
wherein the proxy-relayed ALI portion of the obtained ALI is received within a periodic proxy transmission by the proxy IoT device on behalf of the given IoT device, or
wherein the proxy-relayed ALI portion of the obtained ALI is received in response to a request for the proxy-relayed ALI portion of the obtained ALI that is received from the proxy IoT device on behalf of the given IoT device, or
wherein a first part of the proxy-relayed ALI portion of the obtained ALI is received from the periodic proxy transmission and a second part of the proxy-relayed ALI portion of the obtained ALI is received in response to the request.

13. The method of claim 1, wherein the obtained ALI includes user-centric location description data configured to assist a user to find the IoT device within the IoT environment.

14. The method of claim 13, wherein each of the one or more device classifications identify a class of device expected to be easy for the user to locate within the IoT environment.

15. The method of claim 14, wherein the one or more device classifications include a geo-static appliance or a mobile device that the user is expected to be able to find easily.

16. The method of claim 15, wherein the mobile device that the user is expected to be able to find easily is a vehicle.

17. The method of claim 1, wherein the generating includes adding, to the location profile, ALI that is captured by the IoT device.

18. A method of operating a power-limited Internet of Things (IoT) device that belongs to an IoT environment, comprising:
discovering a plurality of nearby IoT devices along with associated device details for each of the plurality of nearby IoT devices;
selecting at least one of the plurality of nearby IoT devices to act as a proxy IoT device for performing, on behalf of the power-limited IoT device, an augmented location information (ALI) reporting function;
sending, from the power-limited IoT device to the selected proxy IoT device for distribution within the IoT environment in accordance with the ALI reporting function, ALI that identifies (i) a device classification for the power-limited IoT device (ii) or immediate surroundings of the power-limited IoT device; and
refraining from performing the ALI reporting function at the power-limited IoT device based on an expectation that the selected proxy IoT device will be performing the ALI reporting function on behalf of the power-limited IoT device.

19. The method of claim 18, further comprising:
entering a sleep mode to conserve power while periodically waking up to determine whether to determine whether to adjust the ALI reporting function.

20. The method of claim 18, further comprising:
determining to implement an adjustment to the ALI reporting function during a periodic wake up from the sleep mode; and
coordinating with the selected proxy IoT device to implement the adjustment to the ALI reporting function.

21. The method of claim 20,
wherein the adjustment provides updated ALI for the ALI reporting function, or
wherein the adjustment cancels the ALI reporting function.

22. A method of operating a proxy Internet of Things (IoT) device that belongs to an IoT environment, comprising:
reporting device details associated with the proxy IoT device to a power-limited IoT device in the IoT environment;
receiving, in response to the reporting, augmented location information (ALI) that identifies (i) a device classification for the power-limited IoT device and/or (ii) or immediate surroundings of the power-limited IoT device; and
performing an ALI reporting function on behalf of the power-limited IoT device by distributing the ALI to one or more other IoT devices in the IoT environment.

23. The method of claim 22, wherein the ALI reporting function includes:
periodically transmitting some or all of the ALI over the IoT environment, and/or
transmitting some or all of the ALI in response to one or more requests for the ALI from the one or more other IoT devices.

24. The method of claim 22, further comprising:
coordinating with the power-limited IoT device to implement an adjustment to the ALI reporting function.

25. The method of claim 24,
wherein the adjustment provides updated ALI for the ALI reporting function, or
wherein the adjustment cancels the ALI reporting function.

26. The method of claim 22, wherein the ALI includes user-centric location description data configured to assist a user to find the power-limited IoT device within the IoT environment.

27. The method of claim 26, wherein the device classification identifies a class of device expected to be easy for the user to locate within the IoT environment.

28. An Internet of Things (IoT) device within an IoT environment, comprising:
a processor coupled to a memory and configured to:
obtain augmented location information (ALI) that identifies (i) one or more device classifications for one or more IoT devices near the IoT device in the IoT environment and/or (ii) immediate surroundings of the one or more IoT devices; and
generate a location profile of the IoT device based on the ALI.

29. The IoT device of claim 28, wherein the obtained ALI includes a proxy-relayed ALI portion for a given IoT device that is obtained from a proxy IoT device that is configured to provide the proxy-relayed ALI portion of the obtained ALI on behalf of the given IoT device as part of a power-conservation scheme.

30. The IoT device of claim 28,
wherein the obtained ALI identifies the one or more device classifications for the one or more IoT devices near the IoT device in the IoT environment, wherein the processor coupled to the memory is configured to search for nearby IoT devices satisfying a given set of criteria using a first short-range technology with a first range, to repeat the searching using one or more short-range technologies with ranges that are longer than the first range if the nearby IoT devices satisfying the given set of criteria are not detected via the first short-range technology, wherein the obtained ALI corresponds to an associated range of a given short-range technology that detects the nearby IoT devices satisfying the given set of criteria, or
wherein the obtained ALI identifies the immediate surroundings of the one or more IoT devices, and wherein the obtained ALI includes a photograph of the immediate surroundings of the one or more IoT devices and/or first information based on the photograph, or wherein the obtained ALI includes an audio recording that captures sounds emitted in the immediate surroundings of the one or more IoT devices and/or second information based on the audio recording, or
wherein the obtained ALI includes user-centric location description data configured to assist a user to find the IoT device within the IoT environment.
